(19) United States
(12) Patent Application Publication
(10) Pub. No.: US 2023/0030700 A1
(43) Pub. Date: Feb. 2, 2023

(54) METHODS TO AVOID BLUR ADAPTATION USING MYOPIA CONTROL CONTACT LENSES

(71) Applicant: CooperVision International Limited, Fareham (GB)

(72) Inventors: Paul CHAMBERLAIN, Livermore, CA (US); Martin WEBBER, Southampton (GB); Baskar ARUMUGAM, Dublin, CA (US); Arthur BRADLEY, Bloomington, IN (US)

(73) Assignee: CooperVision International Limited, Fareham (GB)

(21) Appl. No.: 17/869,801

(22) Filed: Jul. 21, 2022

Related U.S. Application Data
(60) Provisional application No. 63/226,222, filed on Jul. 28, 2021.

(51) Int. Cl. G02C 7/04

(52) U.S. Cl. CPC G02C 7/044; G02C 7/049; G02C 2202/24

(57) ABSTRACT

Methods for reducing progression of myopia are described. These methods may be understood to be myopia control methods. The methods include a step of providing at least one contact lens having an optic zone and a peripheral zone surrounding the optic zone. The optic zone includes a central region and an annular region that surrounds the central region. The annular region includes a treatment portion that is not rotationally symmetric about an axis of the lens. And, the methods include a step of rotating about the axis, over time, the treatment portion of the at least one contact lens on the eye, wherein the rotation reduces adaptation to a treatment stimulus by the person over time.

This application claims the benefit under 35 U.S.C. § 119(e) of prior U.S. Provisional Patent Application No. 63/226,222, filed Jul. 28, 2021, which is incorporated in its entirety by reference herein.

The present disclosure concerns methods to avoid blur adaptation using myopia control contact lenses.

### BACKGROUND

Myopia (short-sightedness) affects a significant number of people including children and adults. Myopic eyes focus incoming light from distant objects to a location in front of the retina. Consequently, the light converges towards a plane in front of the retina and diverges towards, and is out of focus upon arrival at, the retina. Conventional lenses (e.g. spectacle lenses and contact lenses) for correcting myopia reduce the convergence (for contact lenses), or cause divergence (for spectacle lenses) of incoming light from distant objects before it reaches the eye, so that the location of the focus is shifted onto the retina.

It was suggested several decades ago that progression of myopia in children or young people could be slowed or prevented by under-correcting, i.e. moving the focus towards but not quite onto the retina. However, that approach necessarily results in degraded distance vision compared with the vision obtained with a lens that fully corrects for myopia. Moreover, it is now regarded as doubtful that under-correction is effective in controlling developing myopia. A more recent approach is to provide lenses having both regions that provide full correction of distance vision and regions that under-correct, or deliberately induce, myopic defocus. Lenses may also be provided that increase scattering of light in certain regions of the lenses, compared to light passing through the fully correcting region of the lens. It has been suggested that these approaches can prevent or slow down the development or progression of myopia in children or young people, whilst providing good distance vision.

In the case of lenses having a region that provide defocus, the regions that provide full-correction of distance vision are usually referred to as base power regions and the regions that provide under-correction or deliberately induce myopic defocus are usually referred to as add power regions or myopic defocus regions (because the dioptric power is more positive, or less negative, than the power of the distance regions). A surface (typically the anterior surface) of the add power region(s) has a smaller radius of curvature than that of the distance power region(s) and therefore provides a more positive or less negative power to the eye. The add power region(s) are designed to focus incoming parallel light (i.e. light from a distance) within the eye in front of the retina (i.e. closer to the lens), whilst the distance power region(s) are designed to focus light and form an image at the retina (i.e. further away from the lens).

In the case of lenses that increase scattering of light in a certain region, features that increase scattering may be introduced into a lens surface or may be introduced into the material that is used to form the lens. For example, scattering elements may be burned into the lens.

A known type of contact lens that reduces the progression of myopia is a dual-focus contact lens, available under the name of MISIGHT (CooperVision, Inc.). This dual-focus lens is different than bifocal or multifocal contact lenses configured to improve the vision of presbyopes, in that the dual-focus lens is configured with certain optical dimensions to enable a person who is able to accommodate to use the distance correction (i.e., the base power) for viewing both distant objects and near objects. The treatment portions of the dual-focus lens that have the add power also provide a myopically defocused image at both distant and near viewing distances.

Whilst these lenses have been found to be beneficial in preventing or slowing down the development or progression of myopia, annular add power regions can give rise to unwanted visual side effects. Light that is focused by the annular add power regions in front of the retina diverges from the focus to form a defocused annulus at the retina. Wearers of these lenses therefore may see a ring or ‘halo’ surrounding images that are formed on the retina, particularly for small bright objects such as street lights and car headlights. Also, rather than using the natural accommodation of the eye (i.e. the eye's natural ability to change focal length) to bring nearby objects into focus, in theory, some wearers may make use of the additional focus in front of the retina that results from the annular add power region to focus near objects; in other words, wearers can inadvertently use the lenses in the same manner as presbyopia correction lenses are used, which is undesirable for young subjects.

Further lenses have been developed which can be used in the treatment of myopia, and which are designed to eliminate or reduce the halo that is observed around focused distance images in the MISIGHT (CooperVision, Inc.) lenses and other similar lenses described above. In these lenses, the annular region is configured such that no single, on-axis image from light rays passing through the annular region is formed in front of the retina, thereby preventing such an image from being used to avoid the need for the eye to accommodate near targets. Rather, distant point light sources are imaged by the annular region to a ring-shaped focal line at a near add power focal surface, leading to a small spot size of light, without a surrounding ‘halo’ effect, on the retina at a distance focal surface.

It has been recognised that, over time, the eye may adapt to compensate for myopic defocus or light scattering features provided in a lens. This may reduce the effectiveness of lenses that aim to slow the progression of myopia. The present disclosure seeks to address this, and seeks to provide a method that prevents or slows the worsening of myopia over a longer prolonged period of time.

### SUMMARY

The present invention provides a method of reducing progression of myopia. The method comprises providing at least one contact lens having an optic zone and a peripheral zone surrounding the optic zone. The optic zone comprises a central region and an annular region that surrounds the central region. The annular region includes a treatment portion that is not rotationally symmetric about an axis of the lens. The method comprises rotating, about the axis, over time, the treatment portion of the at least one contact lens on the eye. The rotation reduces adaptation to a symmetric treatment stimulus by the person over time.

### DESCRIPTION OF THE DRAWINGS

FIG. 1 is a schematic graph showing the decrease in modulation transfer function (MTF) with spatial frequency for an aberration free lens without an add power region, and for a lens comprising an annular add power region;

FIG. 2 is a schematic diagram showing visual fields of the eye divided into quadrants;

FIGS. 3A-C are schematic diagrams showing the effect of parallax between the lens and the lens wearer's pupil;

FIG. 4 is a flowchart showing a method of reducing progression of myopia according to an embodiment of the present disclosure.

FIG. 5 is a flowchart showing a method of reducing progression of myopia, wherein rotation occurs using a single lens, according to an embodiment of the present disclosure;

FIG. 6 is a flowchart showing a method of reducing progression of myopia, wherein rotation occurs using two lenses, according to an embodiment of the present disclosure;

FIG. 7 is a schematic top view of a lens with an annular region comprising a plurality of treatment portions, for use in the slowing progression of myopia (e.g., myopia control) according to an embodiment of the present disclosure;

FIG. 8 is a schematic top view of a lens with an annular region comprising a plurality of treatment portions that include scattering elements, for use in the slowing progression of myopia (e.g., myopia control) according to an embodiment of the present disclosure;

FIG. 9A is a schematic top view of a lens with an annular region comprising a plurality of treatment portions that have a curvature providing an add power, for use in the slowing progression of myopia (e.g., myopia control) according to an embodiment of the present disclosure;

FIG. 9B is a schematic ray diagram for the optic zone of the lens of FIG. 9A, taken along the line A-A;

FIG. 10A is a schematic top view of a lens with an annular region comprising a plurality of treatment portions that have a curvature providing an add power, wherein the centre of curvature of the treatment portions is offset from the first optical axis, according to an embodiment of the present disclosure;

FIG. 10B is a schematic partial ray diagram for the optic zone of the lens of FIG. 10A, taken along the line B-B showing the radii of curvature of the central zone and the treatment portions;

FIG. 10C is a further schematic ray diagram for the optic zone of the lens of FIG. 10A, taken along the line B-B.

FIG. 11A is a schematic top view of a lens with a peripheral zone having seed-shaped ballasts, for use in the slowing progression of myopia (e.g., myopia control) according to an embodiment of the present disclosure;

FIG. 11B is a schematic cross section view along the line Y-Y of one of the seed-shaped ballasts of FIG. 11A;

FIG. 12A is a schematic top view of a lens with a peripheral zone having prism-shaped ballasts, for use in the slowing progression of myopia (e.g., myopia control) according to an embodiment of the present disclosure;

FIG. 12B is a schematic cross section view along the line Y-Y of one of the prism-shaped ballasts of FIG. 12A;

FIG. 13A is a schematic top view of a lens with a peripheral zone comprising a continuous ring that provides a varying thickness profile, for use in the slowing progression of myopia (e.g., myopia control) according to an embodiment of the present disclosure;

FIG. 13B is a graph showing the variation in thickness of the continuous ring of FIG. 13A around a portion of the peripheral zone;

FIG. 14A is a schematic top view of a lens with a peripheral zone having ballasts that vary in thickness in a radial direction, for use in the slowing progression of myopia (e.g., myopia control) according to an embodiment of the present disclosure;

FIG. 14B is a schematic cross section taken the line X-X of one of the ballasts of FIG. 14A;

FIG. 14C is a schematic cross section taken the line Y-Y of one of the ballasts of FIG. 14A;

FIG. 15A is a schematic top view of a lens with a peripheral zone comprising a plurality of concentric zones, each concentric zone having seed-shaped ballasts, for use in the slowing progression of myopia (e.g., myopia control) according to an embodiment of the present disclosure;

FIG. 15B is a schematic cross section view taken through one of the seed-shaped ballasts of FIG. 15A;

FIG. 16 is a schematic top view of a set of 7 lenses, each lens having a treatment portion spanning approximately 50° around the annular region, according to an embodiment of the present disclosure;

FIG. 17A is a schematic top view of a set of 2 lenses, each lens having 2 treatment portions, each treatment portion spanning one quadrant of the lens, and each treatment portion having a curvature providing an add power, according to an embodiment of the present disclosure;

FIG. 17B is a schematic cross-section of the first lens of the set of lenses shown in FIG. 17A, taken along the line A-A;

FIG. 17C is a schematic cross-section of the first lens of the set of lenses shown in FIG. 17A, taken along the line B-B;

FIGS. 18A-D are schematic top views of a set of 4 lenses, each lens having a treatment portion spanning one quadrant of the lens, and each treatment portion having a curvature providing an add power with an asymmetric power profile, according to an embodiment of the present disclosure; and

FIGS. 19A-D are graphs showing the asymmetric power profiles as a function of θ for the annular regions of the four lenses in the set shown in FIGS. 18A-D.

### DETAILED DESCRIPTION

The present invention provides, according to a first aspect, a method of reducing progression of myopia. The method comprises providing at least one contact lens having an optic zone and a peripheral zone surrounding the optic zone. The optic zone comprises a central region and an annular region that surrounds the central region. The annular region includes a treatment portion that is not rotationally symmetric about an axis of the lens. The method comprises rotating about the axis, over time, the treatment portion of the at least one contact lens on the eye. The rotation reduces adaptation to a treatment stimulus by the person over time.

As used herein, the term contact lens refers to an ophthalmic lens that can be placed onto the anterior surface of the eye. It will be appreciated that such a contact lens will provide clinically acceptable on-eye movement and not bind to the eye or eyes of a person. The contact lens may be in the form of a corneal lens (e.g., a lens that rests on the cornea of the eye). The contact lens may be a soft contact lens, such as a hydrogel contact lens or a silicone hydrogel contact lens.

A contact lens for use in the present disclosure comprises an optic zone. The optic zone encompasses parts of the lens that have optical functionality. The optic zone is configured to be positioned over the pupil of an eye when in use. For contact lenses according for use in the present disclosure, the optic zone comprises the central region, and the annular region that surrounds the central region and that comprises a treatment portion.

The treatment portion may be a continuous portion. In the context of the present disclosure, the annular region is a substantially annular region that surrounds the optic zone. It may have a substantially circular shape or a substantially elliptical shape. It may fully surround the optic zone. It may partially surround the optical zone.

The optic zone is surrounded by a peripheral zone. The peripheral zone may also be understood to be a carrier zone, as is sometimes used in the art. An edge zone may surround the peripheral zone. The peripheral zone is not part of the optic zone, but sits outside the optic zone and above the iris when the lens is worn, and it provides mechanical functions, for example, increasing the size of the lens thereby making the lens easier to handle, or providing a shaped region that improves comfort for the lens wearer. In some embodiments of the invention, the peripheral zone includes features that promote rotation of the lens on the eye. The peripheral zone may extend to the edge of the contact lens.

As the lens of the present disclosure is designed to rotate on the eye when worn by a wearer, the treatment portion will rotate relative to the eye when the lens is being worn. This is believed to reduce the ability of the eye to compensate for the contrast reducing effects of the treatment portion.

Rotating the treatment portion about an axis of the lens, over time, will result in the treatment portion being moved in front of different regions of the lens wearer's retina, so that the treatment portion will intercept light that is targeted towards different regions of the lens wearer's retina at different times. The treatment portion may therefore span different meridians of the lens wearer's retina at different times. The axis may be the optic axis of the central region. The optic axis may correspond to the geometric center of the optic zone. Or, alternatively, the optic axis may be decentered from the geometric center of the optic zone. The optic axis is generally understood to be the axis orthogonal to the anterior and posterior surface of the contact lens.

The treatment portion of each of the at least one lenses may span less than 50% of the annular region. The treatment portion may span less than half of the annular region. The treatment portion may span less than a quarter of the annular region. Defining the position around the circumference of the annular region by an angle θ, where theta varies between 0° and 360°, the treatment portion of each of the at least one lenses may span less than 10°, or less than 5°.

Rotating the treatment portion over time may involve rotating the treatment portion in discrete rotation steps, such that the treatment portion remains in front of a particular region of the lens wearer's retina for a period of time. Each rotation of the treatment portion may be a rotation by 90° about the axis of the lens and relative to the lens wearer's retina. Each rotation of the treatment portion may be a rotation by less than 10° about the axis of the eye and relative to the lens wearer's retina. Each rotation of the treatment portion may be a rotation by less than 5° about the axis of the lens and relative to the lens wearer's retina.

Rotation of the treatment portion may occur over a timescale of seconds, minutes, hours or days. In between discrete rotation steps, the treatment portion may remain in a fixed position for a second or several seconds. The treatment portion may remain in a fixed position for a minute or several minutes. The treatment portion may remain in a fixed position for an hour or several hours. The treatment portion may remain in a fixed position for a day or several days. The treatment portion may remain in a fixed position for a time period from 5% to 75% of the time period where the contact lens is rotating on the eye. The treatment portion may remain in a fixed position from 20% to 50% of the time period where the contact lens is rotating on the eye.

Rotation of the treatment portion by 360° about the axis of the eye and relative to the lens wearer's retina may take seconds, minutes, hours, or days. Rotation of the treatment portion may reduce adaptation by the lens wearer over a period of hours, days, weeks or months.

The annular zone may comprise a plurality of treatment portions. Each treatment portion may be a treatment portion that has any of the features described above, and each treatment portion may rotate about the axis of the lens, and relative to the lens wearer's retina. A plurality of treatment zones may be distributed such that the annular region is not rotationally symmetric about an axis of the lens. If a plurality of treatment zones are present they may be adjacent to each other, or may be separated around the annular region.

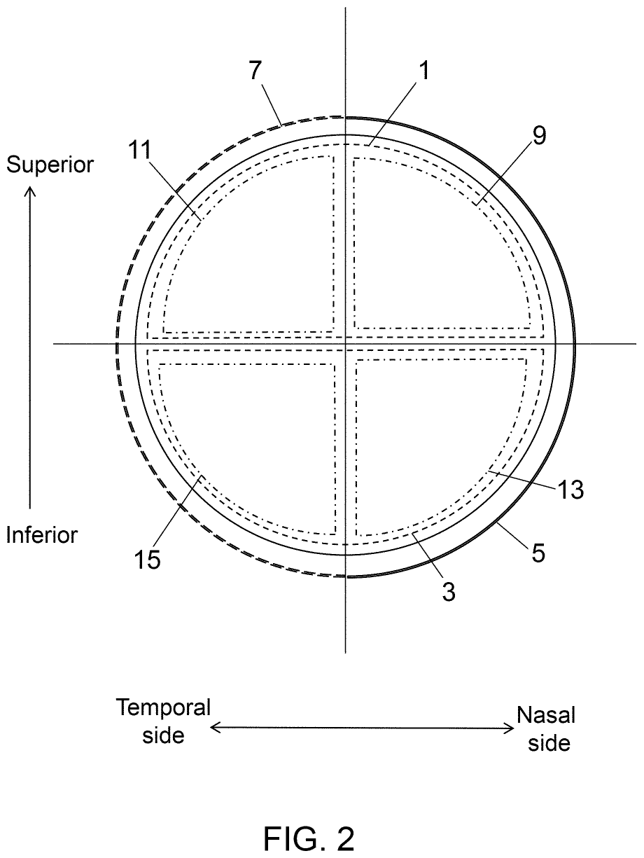

The visual fields of the eye can be divided into quadrants, as shown in FIG. 2, and these quadrants can also be used to describe the quadrants of a contact lens when positioned on an eye. The upper half of the eye/lens is the superior half 1, and the lower half is the inferior half 3. The visual field that is closest to the nose is the nasal half 5, and the visual field that is furthest from the nose is the temporal half 7. Four quadrants can therefore be defined as superior-nasal 9, superior-temporal 11, inferior-nasal 13 and inferior-temporal 15. In the description below, these definitions will be used to describe the position of the add power region and the variation in thickness of the peripheral region as they would be when the lens is in normal use and is being worn by a wearer.

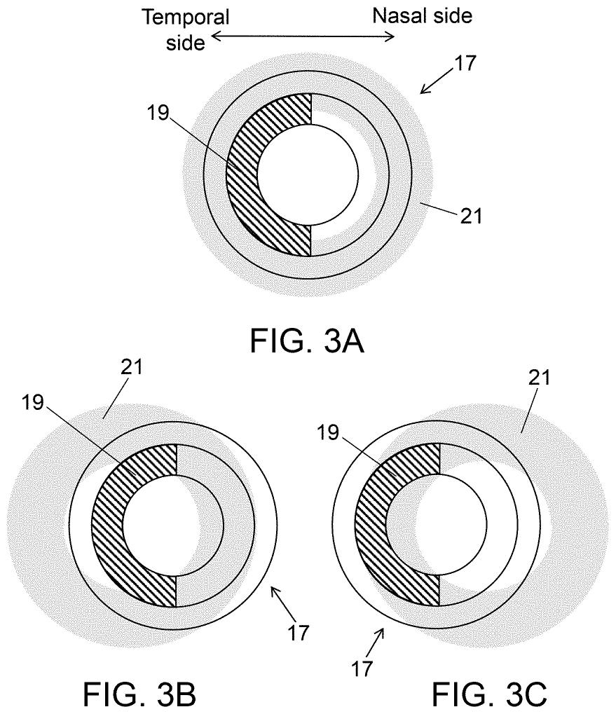

For off-axis light that falls incident on lenses according to embodiments of the present disclosure, there is an approximate mapping of light to each quadrant of the lens wearer's visual field to the opposite quadrant of the retina. Axial separation between the lens when positioned on the anterior surface of the cornea and the position of the wearer's pupil results in parallax, shifting the relative position of the lens and the pupil as viewing angle changes, or as the direction of light incident on the lens changes. This is shown, by way of example, in FIGS. 3A-C, which shows a lens 17 according to an embodiment of the present disclosure, having a treatment portion 19 that spans approximately half of the annular region (the temporal half). The iris 21 is shown schematically as it would be viewed through the cornea. As shown in FIG. 3B, contrast-reducing characteristics of the treatment portion 19 may impact light that is being imaged from the wearer's right visual field, but, as shown in FIG. 3C, contrast-reducing characteristic of the treatment portion 19 will not impact light that is being imaged from the wearer's left visual field. Light from the wearer's left visual field that has passed through the treatment portion 19 will be blocked by the iris 21. For this lens 17, the treatment portion 19 may significantly reduce image contrast for the left retina (nasal retina of the right eye, temporal retina of the left eye), but not for the right retina (temporal retina of the right eye, nasal retina of the left eye). It will be apparent that if the treatment portion spanned the nasal half of the lens instead of the temporal half, the lens may significantly reduce image contrast for the right (temporal) retina, but not for the left (nasal) retina. By including the treatment portion 17 in an annular region of the lens, contrast attenuation may be targeted at a peripheral retinal region whilst minimally disrupting foveal vision.

Each lens for use in a method of the present disclosure may have an annular region comprising a plurality of treatment portions. Each of the plurality of treatment portions may have a characteristic that reduces the contrast of an image of an object that is viewed through the central zone and the treatment portion, compared to an image of an object that is viewed through the central region. The treatment portions may be arranged at regular intervals around the circumference of the annular region. Alternatively, the treatment portions may be arranged at irregular intervals around the circumference of the annular region. Each treatment portion may span between 5% and 10% of the circumference of the peripheral zone. In embodiments of the present disclosure, treatment portions may rotate over time, and may therefore be brought into coincidence with different regions of the eye at different times.

Rotation of the treatment portion may occur, for example, over a time scale of minutes, hours or days.

The treatment portion of each of the at least one lenses may have a characteristic that reduces the contrast of an image that is formed by light passing through the central region and the treatment portion, compared to an image of an object that would be formed by light passing through only the central region. In other words, the treatment portion may cause a reduction in contrast of an image formed by light that has passed through the lens, compared to an image that would be formed by light passing through the same lens without a treatment portion. The treatment portion may comprise contrast-reducing features disposed on a surface of the lens. These features may give rise to additional scattering of light compared to light passing through the remainder of the annular region and the central region. The features may cause light to be diffracted differently compared to light passing through the remainder of the annular region and the central region. The treatment portion may have a curvature that refracts light differently to the remainder of the annular region and the central region, and thereby causes a contrast reduction of an image formed by light passing through the lens.

The contrast reduction may vary across the treatment portion of each lens. The boundary between any of the treatment portions and the remainder of the annular region may be a sharp boundary, or may be a smooth boundary. There may be a blending zone at the boundary between the treatment portion and the remainder of the annular region. The blending zone may have a characteristic that give rise to contrast reduction of an image that is formed by light passing through the lens, compared to an image that would be formed by light passing through the central region of the lens. The characteristic may vary and may dissipate in its contrast-reducing effect moving from the treatment portion to the annular region. For example, if the treatment portion has a curvature providing an add power, a blending zone between the treatment portion and the remainder of the annular region may have a gradual change in curvature, and may result in a gradual reduction in add power across the region. If the treatment portion comprises features that increase scattering of light, a blending zone between the treatment portion and the remainder of the annular region may include features that increase scattering, but the density of these features may vary across the blending zone.

The contrast reduction of an image of an object that is formed by light passing through the central region and the treatment portion compared to an image of an object that would be formed by light passing through only the central region alone can be quantified using the modulation transfer function (MTF).

Lenses do not perfectly reproduce the contrast of an object in an image of the object formed by the lens. The modulation transfer function (MTF) of a given lens measures the ability of the lens to transfer contrast from an object to an image of the object, at a particular resolution, and can be derived from the Fourier transform of the point or line spread function. The MTF can be measured by using a test object (an object to be imaged) of black and white line pairs. As line spacing of a test object decreases, (i.e. as the black and white line pairs get closer together, i.e. as spatial frequency increases), the line spread functions of the black lines start to overlap and so the difference between the black lines and their background is reduced in the image, and the MTF decreases.

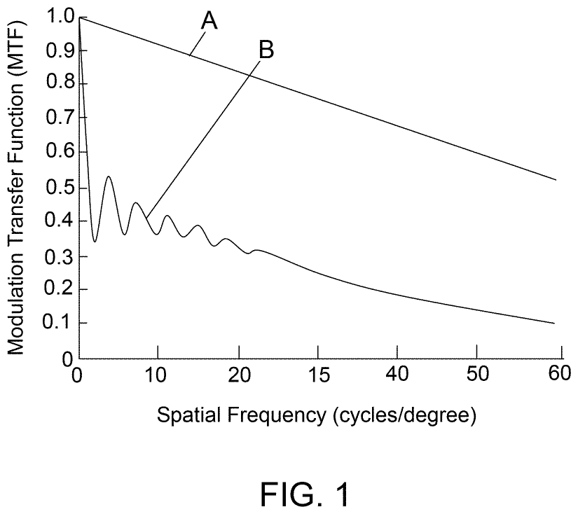

For lenses for use in embodiments of the present disclosure, the presence of the treatment portion reduces the MTF (and hence the contrast) of an image formed by light passing through the treatment portion and the central zone, compared to an image that would be formed by light passing through only the central zone. This can be better understood with reference to FIG. 1. As shown by curve A (line), for an aberration free lens without an add power region, the MTF will decrease as a function of spatial frequency. For lenses that have an optic zone including an annular region having an add power, additional modulation is introduced into the MTF, as shown by curve B.

Thus, the additional contrast attenuation may be a result of a treatment portion that comprises an add power. Alternatively, for example, the treatment portion may comprise features that lead to an increase in light scattering.

For lenses according to embodiments of the present disclosure, the contrast attenuation caused by the treatment portion may give rise to a reduction of contrast for an image formed by light that has passed through the treatment portion and the central zone, compared to an image that would be formed by light that has passed through only the central zone.

The treatment portion of each of the at least one lenses may comprise a strong contrast reduction region having a characteristic that reduces the contrast of an image of an object that is formed by light passing through the treatment portion and the central region compared to an image of an object that would be formed by light passing through only the central region by 50% or more, wherein the area of the strong contrast reduction region is less than 50% of the area of the annular region. The strong contrast reduction region may reduce the contrast of the image formed by the lens by 75% or more. The strong contrast reduction region may span less than 25% of the annular region. The strong contrast reduction region may be a continuous region. There may be a plurality of disconnected strong contrast reduction regions.

The treatment portion of each of the at least one lenses may further comprise a weaker contrasting reduction region having a characteristic that reduces the contrast of an image of an object that is viewed through the treatment portion compared to an image of an object that is viewed through the central region between 10% and 50%. The treatment portion may comprise a periodic arrangement of strong contrast reducing zones separated by weaker contrast reducing zones. The annular region of each lens may comprise a plurality of treatment portions, some of which may be strong contrast reduction regions and others which might be weaker contrast reduction regions.

Each treatment portion of each of the at least one lenses may comprise an add power region having a curvature providing an add power that varies with meridian. The anterior surface of the treatment portion may have a smaller radius of curvature than the radius of curvature of the anterior surface of the central region and the remainder of the annular region. The treatment portion may therefore have a greater power than the base power of the central region and the remainder of the annular region. The focal point of each treatment portion may lie on a proximal focal surface, and the focal point for the central region and the remainder of the annular region may lie on a distal focal surface, which is further away from the posterior surface of the lens. The focal point treatment portion and the focal point of the central region may share a common optical axis. For a point source at infinity, light rays focused by the central region and the annular region form a focused image at the distal focal surface. Light rays focused by the central region also produce an unfocused blur spot at the proximal focal surface. For each lens, at least some of the add power may be provided by curvature that is centred on a centre of curvature that is a first distance from the first optical axis. Light rays from a distant point source that pass through the add power region may be focused away from the first optical axis on a max add power focal surface. Light rays that pass through the central region will form an on-axis blur circle at the max add power focal surface. Light rays from a distant point source that pass through the max add power annular region may be focused outside the blur circle. The central region of the lens has the base power. If the treatment portion comprises an add-power region, the net near power of the treatment portion will be is the sum of the base power and the add power. The centre of curvature of the add power region may be a first distance from the first optical axis.

The treatment portion of the annular region of each of the at least one lenses has a width, and a normal to a surface of the treatment portion taken halfway across the width of the treatment portion may cross a normal, taken at the centre of the central region, at the centre of the curvature of a surface of the central region. The treatment portion may thereby focus light from each distant point object to form a focused arc at a proximal focal surface, the arc being outside of and surrounding the blur circle formed by the light focused by the central region. The surface of the treatment portion may be an anterior surface. The surface of the central zone may be an anterior surface. The surface of the treatment portion may be the surface that has a curvature providing an add power. The surface of the central region may be the surface that has a curvature providing the base power.

The base power of each of the at least one lenses may be positive, and the treatment portion may have a power that is more positive than the base power. In this case, the max add power focal surface will be closer to the lens than the distal focal surface. An on-axis image will not be formed by light passing through the treatment portion. A wearer of each of the at least one lenses will therefore need to use the natural accommodation of their eye to bring nearby objects into focus. It may be that the light rays focused by the treatment portion do not intersect with the first optical axis of the contact lens at all, or not until after they have passed the max add power focal surface.

The base power of each of the at least one lenses may be negative, and the treatment portion may have a power that is less negative than the power of the base region, or the treatment portion may have a positive power. Considering each of the at least one lenses positioned on the cornea, if the power of the treatment portion is less negative than the base power, a max add power focal surface will be more anterior in the eye than the distal focal surface. Considering each of the at least one lenses when it is not positioned on the cornea, if the power of the treatment portion is positive, a max add power focal surface will be on the opposite (image) side of the lens than the distal focal surface (which will be a virtual focal surface on the object side of the lens); if the power of the treatment portion is negative (but less negative than the base power), a virtual add power focal surface will be further from the lens than a virtual distal focal surface.

In embodiments wherein each of the at least one lenses has a plurality of treatment portions each of the treatment portions of a given lens may have a curvature providing the same add power, or each of the treatment portions of a given lens may have curvatures that provide different add powers.

The treatment portion of each of the at least one lenses may have an asymmetric power profile. A curvature providing an add power may be a curvature of the anterior surface of the lens. For each of the at least one lenses, a curvature providing an add power may be a curvature of the posterior surface of the lens. For each of the at least one lenses, a curvature providing an add power may be a curvature of the anterior surface and the posterior surface of the lens providing a combined effect.

For lenses used in the correction of myopia, the base power will be negative or close to zero, and the central region will correct for distance vision. The base power may be between 0.5 diopters (D) and −20.0 diopters. The base power may be from −0.25 D to −20.0 D. Add power is defined as the difference between the base power and the power of the add power meridian. For each of the at least one lenses, an add power provided by each treatment portion may between +0.5 and +10.0 D, preferably between +2.0 and +3.0 D. For a lens having a positive base power, the power of any add power regions will be more positive than the base power and similarly, for a lens having a lens having a negative base power, the power of each of any add power regions may be less negative than the base power, or the power of any add power regions may be a positive power. The net power of the annular region in any add power region will be the sum of the base power and the add power.

The treatment portion of each of the at least one lenses may include a feature that increases scattering of light passing through the treatment portion compared to light passing through only the central region. The feature may be disposed on an anterior surface of the annular region. The treatment portion of each lens may comprise optical elements burned into a surface of the lens, or etched into the surface of the lens. Features that increase scattering of light passing through the treatment portion will reduce the contrast of an image formed from light passing through the treatment portion and the central region, compared to an image that would be formed from light that has only passed through only the central region. As the at least one lens rotates over time, the high scattering region will target light towards different regions of the retina. This may reduce the ability of the eye to compensate for the reduced contrast caused by the scattering.

The treatment portion of each of the at least one lenses may have a curvature providing an add power wherein the centre of curvature is on the first optical axis.

The treatment portion of each of the at least one lenses may include a characteristic that causes diffraction of light passing through the treatment portion. The treatment portion of each of the at least one lenses may include other characteristics that reduce the contrast of an image formed by light passing through the treatment portion and the central region, compared to an image that would be formed by light passing through only the central region.

Each of the at least one lenses may be substantially circular in shape and have a diameter (i.e., a chord diameter) from about 4 mm to about 20 mm, preferably between about 13.0 mm and 15.0 mm. As used herein a reference to a diameter is a reference to a chord diameter. The centre thickness of each of the at least one lenses may between about 50 micrometres and about 300 micrometres. The peripheral zone of each of the at least one lenses may have a thickness of between about 50 micrometres and about 450 micrometres. The lens thickness can be measured using conventional techniques and instruments such as a Rehder gauge. The central region may be substantially circular in shape and may have diameter of between about 2 and 9 mm, preferably between about, and more preferably between about 2 and 5 mm. The central region may be substantially elliptical in shape. The base curve may have a radius of curvature of between about 8.0 mm and 9.0 mm. The annular region may extend radially outwards from a perimeter of the central region by between about 0.1 to 4 mm, preferably between about 0.5 to 1.5 mm. For example, the radial width of the annular region may be about 0.1 mm to about 4 mm, and preferably may be about 0.5 mm to about 1.5 mm. The perimeter of the central region may define a boundary between the central region and the annular region, and the annular region may therefore be adjacent to the central region.

The annular region of each of the at least one lenses may abut the central region. A blending region may be provided between the central region and the annular region. The blending region should not substantially affect the optics provided by the central region and the annular region, and the blending region may have a radial width of 0.05 mm or less, although it may also be as wide as 0.2 mm, or as wide as 0.5 mm in some embodiments.

The annular region may extend radially outwards to abut the peripheral zone. The treatment portion may span the radial width of the annular zone.

Each of the at least one lenses may include a plurality of concentric annular regions. Each annular region may be an annular region including a treatment portion having the characteristics outlined above.

The central region of each of the at least one lenses has a base power, which in the context of the present disclosure, is defined as the average absolute refractive power of the central region. Any base power meridians will also have the base power. The base power will correspond to the labelled refractive power of the contact lens as provided on the contact lens packaging (though in practice it may not have the same value). Thus, the lens powers given herein are nominal powers. These values may differ from lens power values obtained by direct measurement of the lens, and are reflective of the lens powers that are used to provide a required prescription power when used in ophthalmic treatment.

The method of the present disclosure may comprise providing a contact lens that is configured to rotate in response to a force when worn by a wearer, and wherein the step of rotating comprises subjecting the lens to a force imparted by the lens wearer, wherein the force results in rotation of the treatment portion over time about the axis of the lens. Rotation of the treatment portion relative to the eye of the lens wearer will bring the treatment portion into coincidence with different regions the lens wearer's retina, and the treatment portion may therefore intercept light that is targeted towards different regions of the retina at different times. For this embodiment of the disclosure, rotation of the treatment portion may be achieved using a single lens. A lens wearer may be provided with a lens for wearing on the left eye and a lens for wearing on the right eye. It will be appreciated that a wearer may be provided with a lens for wearing on the right eye, and a lens for wearing on the left eye. The method may comprise providing a lens wearer with a prescription schedule instructing the lens wearer with which lens to wear in which eye. A prescription schedule may instruct the lens wearer with how long to wear a lens for.

The step of rotating may comprise a lens wearer blinking, thereby imparting a force on the lens. When the lens is being worn, a force may be imparted on the lens from the lens wearer's eyelids, for example, when the lens wearer blinks. The lens wearer's eyelids may impart opposite translational forces on the lens, and this may result in rotation of the lens on the eye of the lens wearer. Rotation of the lens may also be assisted by gravitational forces acting upon the lens. As the lens rotates, different parts of the retina will be exposed to different amounts of defocus, and this may be more effective in slowing the growth of myopia than wearing a single lens that provides a constant myopic defocus. It is believed that rotation of the treatment portion relative to the eye of the lens wearer may reduce the ability of the eye to compensate for any contrast reducing effects of the treatment portion. The step of rotating may comprise a lens wearer blinking repeatedly, thereby repeatedly imparting a force on the lens.

The treatment portion may be configured to rotate by a fixed amount relative to the axis of the lens, in response to a force acting on the lens. Each time a force is imparted on the lens, the treatment portion may rotate by a fixed amount relative to the axis and relative to the lens wearer's retina. Each time a force is imparted, the treatment portion may rotate by a fixed number of degrees. The force may be a force imparted by a lens wearer blinking, and each blink may cause the treatment portion to rotate by a fixed amount about the axis and relative to the lens wearer's retina. For example, the treatment portion may rotate by 5° each time a lens wearer blinks. The lens may rotate by 360° over a timescale of minutes or over a timescale of hours.

The peripheral zone of each of the at least one lenses may comprise a variation in thickness configured to promote rotation of the lens. In known contact lenses, for example, in toric lenses, the peripheral zone may provide ballasting to prevent or limit rotation of the lens about the optical axis when the lens is worn by a wearer. However, lenses for use in embodiments of the present disclosure may be designed to rotate on the eye, and the peripheral zone may either have a constant thickness profile or a thickness profile that is configured to promote rotation of the lens. In embodiments where the peripheral zone has a constant thickness in every meridian, the peripheral zone will not provide a ballasting effect and thus when the lens is worn by a wearer, it will rotate about the optical axis in response to a rotational force. In these embodiments, the thickness variation is the same in every meridian. The thickness profile may either vary along the meridian, or may be constant along the meridian. In embodiments where the peripheral zone has a thickness profile configured to promote rotation of the lens, the thickness of the peripheral zone may vary with meridian. The thickness profile variation may result from features disposed on a surface of the peripheral zone. The features may be designed to promote rotation of the lens in one direction about the optical axis in response to a rotational force. Rotation of the lens may also be assisted by gravitational forces acting upon the lens.

The thickness profile of each of the at least one lenses may have no axis of mirror symmetry. The thickness variation of the peripheral zone may vary in an aperiodic or irregular manner around all or part of the lens. The variation in thickness may be selected to achieve a desired amount of contact lens rotation on the eye without significantly decreasing contact lens comfort or lens awareness compared to a conventional spherical contact lens. For example, a peripheral zone thickness variation may be chosen based on a thickness variation that has been clinically tested on an eye of a person. The amount of lens rotation can be observed by an eye care practitioner using a slit lamp or other conventional tool. Typically, multiple contact lenses with different thickness profiles will be manufactured and tested on-eye of many people (e.g., 20 or more) to assess lens rotation and lens comfort. If the lens rotation is insufficient, or if lens comfort is significantly reduced compared to a control lens, then a lens with a different thickness profile in the peripheral zone is manufactured and tested. The thickness of the peripheral zone may be constant on one half of the lens and varies on the other half of the lens. Half of the lens may have a peripheral zone thickness that varies in an irregular or aperiodic manner. Half of the lens may provide a prism ballast or a periballast.

The thickness of the peripheral zone may vary periodically around the lens. The peripheral zone may comprise a plurality features that alter the thickness of the peripheral region. These features may be spaced at regular intervals around the lens. Each feature may have an asymmetric profile that promotes rotation of the lens in one direction. The features may be aligned such that the non-rotational force of blinking is translated into a rotational force, such that the lens rotates in one direction. Each feature may be provided on a surface of the peripheral zone.

The periodic variation may be a sinusoidal waveform, a triangular waveform, or a sawtooth waveform. The periodic variation may span a portion of the circumference of the peripheral zone, or the entire circumference of the peripheral zone.

In embodiments of the present disclosure, the method comprises providing at least two lenses, wherein a first lens provides a treatment portion that is configured to span a first region of the lens wearer's eye, and wherein at least one additional lens provides a treatment portion that is configured to span a different region of the lens wearer's eye, and wherein the step of rotating comprises a wearer wearing the first lens and then each of the at least one additional lenses in succession. Both the first lens and each additional lens may include any of the features set out above. The treatment portions of the each of the lenses may include any of the features set out above. The treatment portions of each of the lenses may have the same characteristics, similar characteristics or characteristics that result in the same effect. More than two lenses may be provided, and in this case, each lens will have a treatment portion that spans a different region of the lens wearer's eye. The regions of the eye spanned by each of the lenses may partially overlap. If the lens wearer wears the lenses in succession, a treatment portion will span different regions of the lens wearer's eye at different times, and will therefore intercept light targeted towards different regions of the retina at different times. This results in a rotation of a treatment portion when the lenses are worn in succession by a wearer. Different parts of the eye will be exposed to different amounts of defocus at different times, and this may be more effective in slowing the growth of myopia than wearing a single lens that provides a myopic defocus that spans a fixed region of the lens wearer's eye. It is believed that this may reduce the ability of the lens wearer's eye to compensate for the effect of the treatment portion.

In embodiments of the present disclosure that provide a first lens and at least one second lens, the peripheral zone of each lens may have a varying thickness profile that is configured to control rotation of the lens. The first lens may have a treatment portion rotationally positioned relative to the peripheral zone thickness profile, at a first angle, and each of the at least one additional lenses may have a treatment portion that is rotationally positioned, relative to the peripheral zone thickness profile at a different angle.

Each lens may have the same peripheral zone thickness profile or a peripheral zone thickness profile that gives rise to the same effect. The variation in thickness of the peripheral zone of each lens may be configured to stabilise the lens in a particular orientation. The variation in thickness may be a continually varying thickness around the peripheral zone. The thickness of the peripheral zone may increase towards the bottom of the lens (considering the lens in its normal orientation, when worn by a wearer). The variation in thickness may result from a curvature of the anterior surface of the peripheral zone. The variation in thickness may result from a curvature of the posterior surface of the peripheral zone. The variation in thickness may result from a combination of curvatures of the posterior and anterior surfaces of the peripheral zone. The variation in thickness of thickness of the peripheral zone may be configured to promote rotation of the lens in a particular direction. The peripheral zone may include a ballast to orient the lens when positioned on the eye of a wearer. The ballast may be a prism ballast. When placed on the eye of a wearer, the lens may rotate, under the action of the wearer's eyelid, and as a result of gravitational forces, to a pre-determined angle of repose. The ballast may be a wedge and the rotation may result from a rotational force imparted by the wearer's eyelids on the wedge. The ballast may be a periballast. The ballast may be a dynamic stabilisation feature, for example, comprising two thin zones lying along the diameter separating the nasal and temporal halves of the lens, one zone being positioned in the superior half of the lens, and the other being positioned in the inferior half of the lens. A prism ballast may comprise a plurality of bands of increasing thickness. The bands may be arranged such that the thinnest band is positioned towards the centre of the lens at the boundary of the peripheral zone and the optic zone, and the thickest band is positioned towards the edge of the peripheral zone. The maximum thickness of the ballast may be between 250 and 450 micrometers. The minimum thickness of the ballast may be between 50 and 100 micrometers. The rotation may also be assisted by gravitational forces acting on the lens. Each lens in the set of lenses may have the same peripheral zone thickness variation, or each lens in the set of lenses may have a peripheral zone thickness variation that causes the same or a similar effect when the lens is worn by a wearer. For example, each lens in the set of lenses may have a peripheral zone thickness variation that results in the lens rotating to be in the same orientation about the first optical axis when the lens is worn by the wearer.

The method may comprise providing a lens wearer with a set of instructions regarding wearing the lenses. The step of rotating the treatment portion may comprise a lens wearer wearing the first lens and then each additional lens in succession. The step of rotating the treatment portion may comprise a lens wearer removing and replacing the first lens with one of the additional lenses lens after an hour, or after a day. The step of rotating the treatment portion may comprise a lens wearer alternating between wearing a first lens and each of the at least one additional lenses. The first lens and each of the additional lenses may be worn once, or may be worn multiple times by a lens wearer.

The method may comprise providing a lens wearer with a prescription schedule indicating the order in which the first lens and each of the at least one additional lenses should be worn. A prescription schedule may indicate how long a lens wearer should wear each lens for. A prescription schedule may indicate the orientation in which a lens should be worn. A prescription schedule may indicate which lens of a lens set should be worn.

The method may comprise providing a lens wearer with a set of lenses, wherein each lens in the set of lenses provides a treatment portion that is configured to span a different region of the lens wearer's eye, and wherein the step of rotating comprises the lens wearer wearing the lenses in succession. Each lens in the set may have the same peripheral zone thickness variation, or a peripheral zone thickness variation giving rise to the same effect, as described above. Each lens in the set may have the same, or a similar treatment portion, or a treatment portion that has the same characteristic or gives rise to the same effect. Each lens in the set may have a treatment portion that is positioned at a different angle relative to the peripheral zone thickness variation, such that when each lens in the set is worn by a lens wearer, the treatment portion intercepts light targeted towards a different region of the eye. If a lens wearer wears each lens in the set in succession, the lens wearer's retina may be subject to a treatment portion that rotates about the optical axis of the retina. This effectively results in rotation of the treatment portion over time. The set of lenses may comprise a set of 7 lenses for wearing on each day of the week, and the step of rotating may comprise the lens wearer wearing each lens in the set on successive days of the week. A lens wearer may be provided with a set of instructions or a prescription schedule indicating the order in which the lenses in the set should be worn and/or indicating how long each lens in the set should be worn for.

The method may comprise providing at least one lens for wearing on the right eye, and at least one lens for wearing on the left eye, wherein each lens has an optic zone and a peripheral zone surrounding the optic zone, the optic zone comprising a central region and an annular region that surrounds the central region, the annular region including a treatment portion. The method may comprise rotating over time the treatment portion of each of the contact lenses on the lens wearers eyes. Each of the at least one lenses for wearing on the right eye, and each of the at least one lenses for wearing on the left eye will have an optic zone and a peripheral zone surrounding the optic zone, the optic zone comprising a central region and an annular region that surrounds the central region, the annular region including a treatment portion. The method comprises rotating over time the treatment portion relative to the axis of the lens. Considering pair of lenses (a right eye lens and a left eye lens) for wearing at a given time, both lenses may have a treatment portion that initially spans the same portion of the annular region. For example, both lenses may have a treatment portion that initially spans the temporal half of the lens, targeting the nasal retina. In this case, initially, the treatment portion of the right eye lens will have a strong contrast reducing effect on the left retina of the right eye. The treatment portion of the left eye lens will have a strong contrast reducing effect on the right retina of the left eye. Correspondingly, the right eye lens will have a weak contrast reducing effect at the right retina of the right eye, and the left eye lens will have a weak contrast reducing effect at the left retina of the left eye. The brain will receive signals from both the eyes and both regions of the retina, but the weakly contrast reduced image will dominate the binocular neural image in the cortex. Therefore, at the level of perception, image degradation may be avoided during normal binocular viewing.

The at least one lens for wearing on the left eye and the at least one lens for wearing on the right eye may be configured to rotate in response to a force when worn by a wearer, and wherein the step of rotating may comprise subjecting the lenses to a forces imparted by the lens wearer, wherein the forces results in rotation of the lenses.

The method may comprise providing a set of lenses for wearing on the right eye and a set of lenses for wearing on the left eye. Within each set, a first lens may provide a treatment portion that is configured to span a first region of the lens wearer's retina, and at least one second lens may provide a treatment portion that is configured to span a second, different region of the lens wearer's retina. The step of rotating may comprise a wearer wearing the first lenses (for the right eye and the left eye) and then the second lenses (for the right eye and the left eye) in succession. Each lens in the first set may have a corresponding lens in the second set, and pairs of corresponding lenses may have treatment portions spanning the same annular region.

Each lens may comprise an elastomer material, a silicone elastomer material, a hydrogel material, or a silicone hydrogel material, or combinations thereof.

As understood in the field of contact lenses, a hydrogel is a material that retains water in an equilibrium state and is free of a silicone-containing chemical. A silicone hydrogel is a hydrogel that includes a silicone-containing chemical. Hydrogel materials and silicone hydrogel materials, as described in the context of the present disclosure, have an equilibrium water content (EWC) of at least 10% to about 90% (wt/wt). In some embodiments, the hydrogel material or silicone hydrogel material has an EWC from about 30% to about 70% (wt/wt). In comparison, a silicone elastomer material, as described in the context of the present disclosure, has a water content from about 0% to less than 10% (wt/wt). Typically, the silicone elastomer materials used with the present methods or apparatus have a water content from 0.1% to 3% (wt/wt). Examples of suitable lens formulations include those having the following United States Adopted Names (USANs): methafilcon A, ocufilcon A, ocufilcon B, ocufilcon C, ocufilcon D, omafilcon A, omafilcon B, comfilcon A, enfilcon A, stenfilcon A, fanfilcon A, etafilcon A, senofilcon A, senofilcon B, senofilcon C, narafilcon A, narafilcon B, balafilcon A, samfilcon A, lotrafilcon A, lotrafilcon B, somofilcon A, riofilcon A, delefilcon A, verofilcon A, kalifilcon A, lehfilcon A, and the like.

Alternatively, each lens may comprise, consist essentially of, or consist of a silicone elastomer material. For example, the lens may comprise, consist essentially of, or consist of a silicone elastomer material having a Shore A hardness from 3 to 50. The shore A hardness can be determined using conventional methods, as understood by persons of ordinary skill in the art (for example, using a method DIN 53505). Other silicone elastomer materials can be obtained from NuSil Technology or Dow Chemical Company, for example.

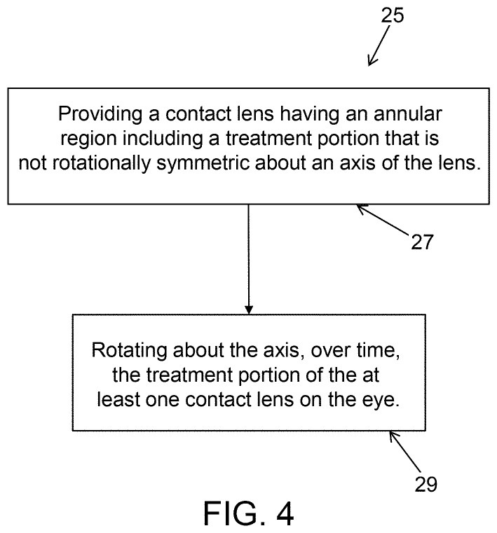

FIG. 4 is a flowchart showing a method 25 of reducing progression of myopia according to an embodiment of the present disclosure. In a first step 27, the method comprises providing at least one contact lens having an optic zone and a peripheral zone surrounding the optic zone. The optic zone comprises a central region and an annular region that surrounds the central region. The annular region includes a treatment portion that is not rotationally symmetric about an axis of the lens. In a second step 29, the method comprises rotating about the axis, over time, the treatment portion of the at least one contact lens on the eye. The rotation reduces adaptation to a treatment stimulus by the person over time.

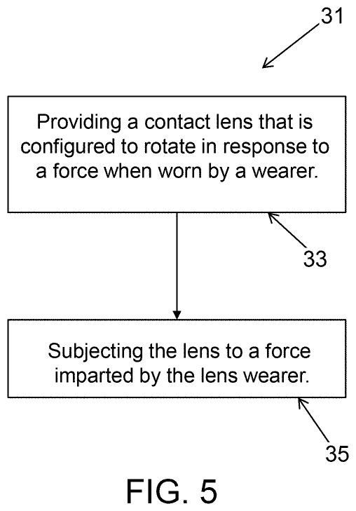

FIG. 5 is a flowchart showing a method 31 of reducing progression of myopia according to an embodiment of the present disclosure wherein rotation of the treatment portion occurs using a single lens. In a first step 33, the method comprises providing a contact lens that is configured to rotate in response to a force when worn by a wearer. In a second step 35, the lens is subjected to a force imparted by the lens wearer. The force results in rotation of the treatment portion.

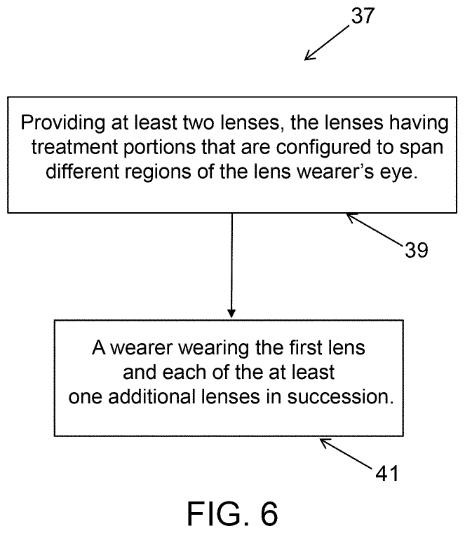

FIG. 6 is a flowchart showing a method 37 of reducing progression of myopia according to an embodiment of the present disclosure wherein the rotation of the treatment portion occurs by providing a lens wearer with at least two lenses having treatment portions that are configured to span different regions of the lens wearer's eye. In a first step 39, the method comprises providing at least two lenses, wherein a first lens provides a treatment portion that is configured to span a first region of the lens wearer's eye, and wherein at least one additional lens provides a treatment portion that is configured to span a different region of the lens wearer's eye. In a second step 41, the method comprises a wearer wearing the first lens and each of the at least one additional lenses in succession.

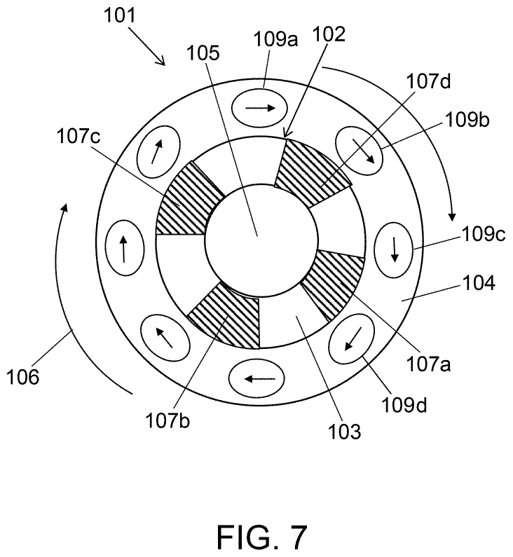

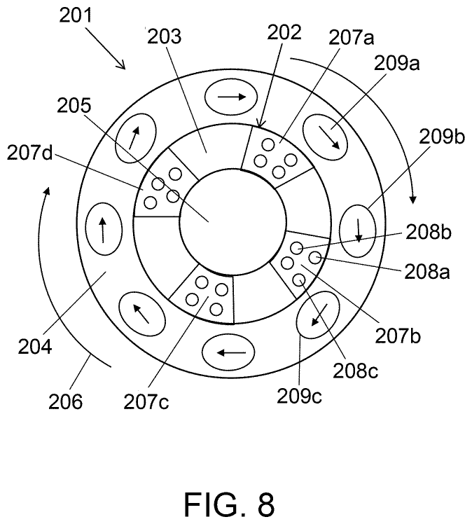

FIG. 7 shows a schematic top view of a lens 101 for use in the method of slowing progression of myopia according to an embodiment of the present disclosure. The optic zone 102 comprises a central region 105 surrounded by an annular region 103. The annular region 103 comprises a plurality of treatment portions 107a, 107b, 107c, 107d, that reduce the contrast of an image of an object that is formed by light passing through the central region and the treatment portion compared to an image of an object that would be formed by light passing through only the central region 105. In between the treatment portions 107a, 107b, 107c, 107d there are regions that do not significantly reduce the contrast of an image formed by light passing through the lens 101. The peripheral zone 104 comprises a plurality of seed-shaped ballasts 109a, 109b, 109c, disposed on the anterior surface of the lens 101 and arranged at regular intervals around the circumference of the lens 101. These seed-shaped ballasts 109a, 109b, 109c, 109d are described in more detail with reference to FIG. 8 below. The ballasts 109a, 109b, 109c, 109d promote rotation of the lens 101 about the first optical axis in a clockwise direction, as indicated by the arrow 106. If a wearer of the lens 101 blinks, their eyelid will impart a force on the ballasts 109a, 109b, 109c, 109d, thereby causing the lens 101 to rotate. As the lens 101 rotates about the first optical axis in response to a force, the treatment portions 107a, 107b, 107c, 107d will be brought into coincidence with different regions of the eye. This may reduce the ability of the eye to compensate for the contrast reduction caused by the treatment portions 107a, 107b, 107c, 107d.

FIG. 8 shows a schematic top view of a lens 201 for use in the method of slowing progression of myopia (e.g., myopia control) according to an embodiment of the present disclosure. The optic zone 202 comprises a central region 205 surrounded by an annular region 203. The annular region 203 comprises a plurality of treatment portions 207a, 207b, 207c, 207d, that increase the scattering of light passing through the treatment portions, thereby reducing the contrast of an image of an object that is formed by light passing through the central region and the treatment portion compared to an image of an object that would be formed by light passing through only the central region 205. Each treatment portion 207a, 207b, 207c, 207d comprises a plurality of scattering elements 208a, 208b, 208c which have been burned into the anterior surface of the annular region 203. In between the treatment portions 207a, 207b, 207c, 207d there are regions that do not significantly reduce the contrast of an image formed by light passing through the lens 201. The peripheral zone 204 comprises a plurality of seed-shaped ballasts 209a, 209b, 209c, disposed on the anterior surface of the lens 201 and arranged at regular around the circumference of the lens 201. These ballasts 209a, 209b, 209c, promote rotation of the lens 201 about the first optical axis in a clockwise direction, as indicated by the arrow 206. If a wearer of the lens 201 blinks, their eyelid will impart a force on the ballasts 209a, 209b, 209c, thereby causing the lens 201 to rotate. As the lens 201 rotates about the first optical axis in response to a force, the treatment portion 207a, 207b, 207c, 207d will be bought into coincidence with different regions of the eye. This may reduce the ability of the eye to compensate for the increased scattering of light caused by the treatment portion 207a, 207b, 207c, 207d.

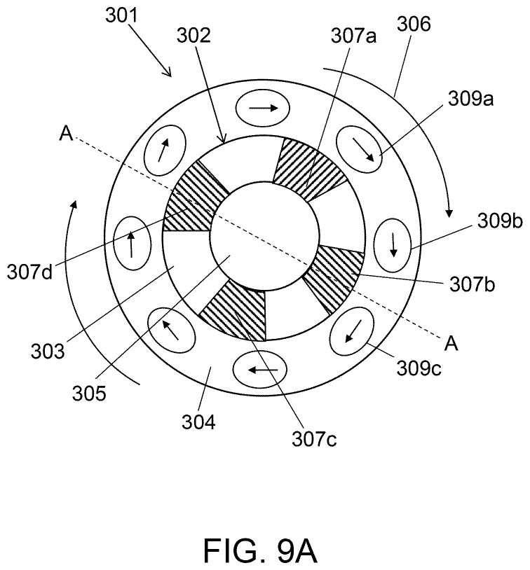

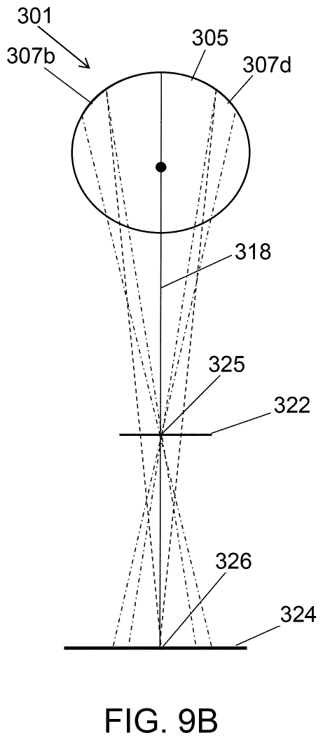

FIG. 9A shows a schematic top view of a lens 301 for use in the method of slowing progression of myopia (e.g., myopia control) according to an embodiment of the present disclosure. The optic zone 302 comprises a central region 305 surrounded by an annular region 303. The central region 305 has a curvature providing a base power and centred on a centre of curvature that is on the first optical axis 318. This is shown in FIG. 9B which is a schematic of a cross section through the optic zone of the lens taken along the line A-A.

The annular region 303 comprises a plurality of treatment portions 307a, 307b, 307c, 307d. Each treatment portion 307a, 307b, 307c, 307d has a curvature that provides an add-power. The radius of curvature of the anterior surface of the treatment portions 307a, 307b, 307c, 307d is smaller than the radius of curvature of the anterior surface of the central region 305. The treatment portions 307a, 307b, 307c, 307d therefore have a greater power than the base power of the central region 305. As shown in FIG. 9B, the focal point 325 of the treatment portions 307b, 307d lies on a proximal focal surface 322, and the focal point 326 for the central region 305 lies on a distal focal surface 324, which is further away from the posterior surface of the lens 301. The focal point 325 of the treatment portions 307b, 307d and the focal point 324 of the central region 305 share a common optical axis 318. For a point source at infinity, light rays focused by the central region 305 form a focused image at the distal focal surface 324. Light rays focused by the central region 305 also produce an unfocused blur spot at the proximal focal surface 322. Light rays focused by the treatment portions 307b, 307d form a focused image at the proximal focal surface 322. Light rays focused by the treatment portions 307b, 307d diverge after the proximal focal surface 322.

The add-power treatment portions 307a, 307b, 307c, 307d reduce the contrast of an image of an object that is formed by light passing through the central region and the treatment portion compared to an image of an object that would be formed by light passing through only the central region 305. In between the treatment portions 307a, 307b, 307c, 307d there are regions that do not significantly reduce the contrast of an image formed by light passing through the lens 301. The peripheral zone 304 comprises a plurality of seed-shaped ballasts 309a, 309b, 309c, disposed on the anterior surface of the lens 301 and arranged at regular intervals around the circumference of the lens 301. These ballasts 309a, 309b, 309c, promote rotation of the lens 301 about the first optical axis in a clockwise direction, as indicated by the arrow 306. If a wearer of the lens 301 blinks, their eyelid will impart a force on the ballasts 309a, 309b, 309c, thereby causing the lens 301 to rotate. As the lens 301 rotates about the first optical axis in response to a force, the treatment portions 307a, 307b, 307c, 307d will be brought into coincidence with different regions of the eye. This reduces the ability of the eye to compensate for the defocusing effect of the treatment portions 307a, 307b, 307c, 307d.

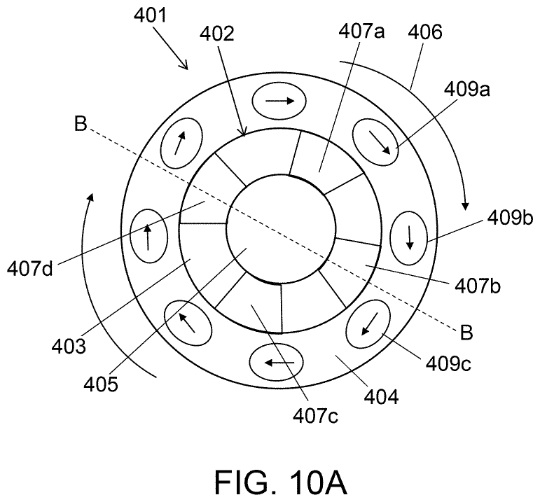

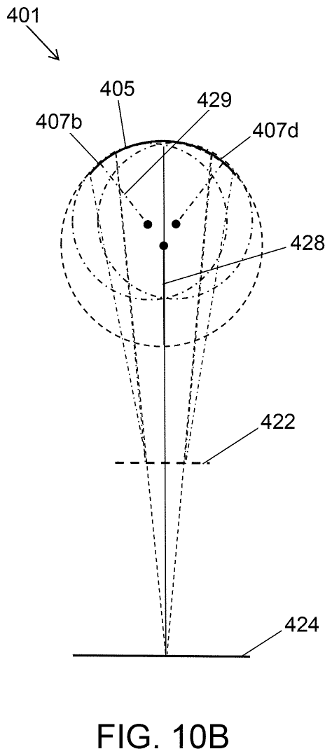

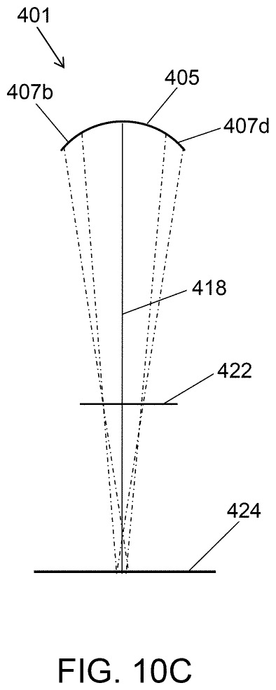

FIG. 10A shows a schematic top view of a lens 401 for use in the method of slowing progression of myopia (e.g., myopia control) according to an embodiment of the present disclosure. The optic zone 402 comprises a central region 405 (also shown in FIGS. 10B and 10C) surrounded by an annular region 403. The central region 405 has a curvature providing a base power and centred on a centre of curvature that is on the first optical axis 418 (shown in FIG. 10C). This is shown in FIG. 10B which is a schematic of a cross section through the lens taken along the line B-B.

As shown in FIG. 10A, the annular region 403 comprises a plurality of treatment portions 407a, 407b, 407c, 407d. Each treatment portion 407a, 407b, 407c, 407d has a curvature that provides an add-power. The radius of curvature of the anterior surface of the treatment portions 407a, 407b, 407c, 407d (indicated by the dashed circles) is smaller than the radius of curvature of the anterior surface of the central region 405. The treatment portions 407a, 407b, 407c, 407d therefore have a greater power than the base power of the central region 405. As shown in FIG. 10B, the anterior surface of the central region 405 defines a portion of a surface of a sphere of radius 428 (with sphere indicated by the dot dash circle). The anterior surface of the treatment portions 407b, 407d defines a curved annular surface with radius of curvature 429.

As shown in FIGS. 10B and 10C, at the distal focal surface 424, light rays passing through the central region 405 are focused. A single image is not formed at the proximal focal surface 422. At the proximal focal surface 422, for a point source at infinity, light rays passing through the central region 405 generate a blur circle. However, light rays from a distant point source passing through the treatment portions 407b, 407d, generate focused arcs which surround the blur circle.

The add-power treatment portions 407a, 407b, 407c, 407d reduce the contrast of an image of an object that is formed by light passing through the central region and the treatment portion compared to an image of an object that would be formed by light passing through only the central region 405. In between the treatment portions 407a, 407b, 407c, 407d there are regions that do not significantly reduce the contrast of an image formed by light passing through the lens 401. The peripheral zone 404 comprises a plurality of seed-shaped ballasts 409a, 409b, 409c, disposed on the anterior surface of the lens 401 and arranged at regular intervals around the circumference of the lens 401. These ballasts 409a, 409b, 409c, promote rotation of the lens 401 about the first optical axis in a clockwise direction, as indicated by the arrow 406. If a wearer of the lens 401 blinks, their eyelid will impart a force on the ballasts 409a, 409b, 409c, thereby causing the lens 401 to rotate. As the lens 401 rotates about the first optical axis in response to a force, the treatment portions 407a, 407b, 407c, 407d will be bought into coincidence with different regions of the eye. This reduces the ability of the eye to compensate for the defocusing effect of the treatment portions 407a, 407b, 407c, 407d.

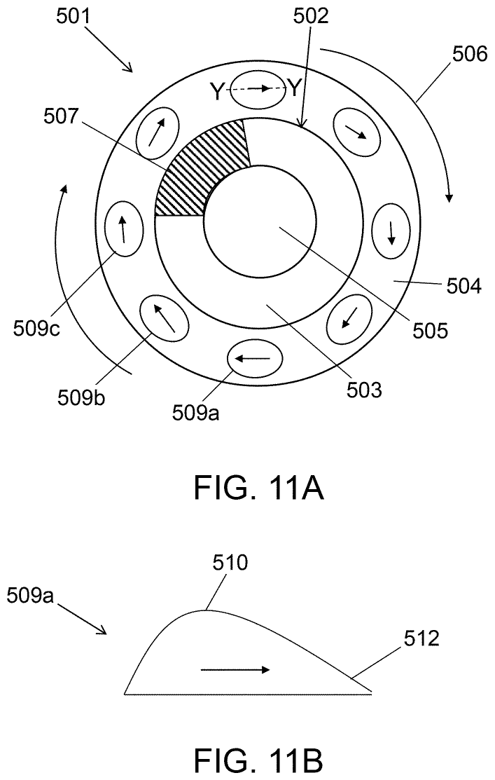

FIG. 11A shows a schematic top view of a lens 501 for use in the method of slowing progression of myopia (e.g., myopia control) according to an embodiment of the present disclosure. The optic zone 502 of the lens 501 comprises a central region 505 surrounded by an annular region 503. The annular region 503 comprises a treatment portion 507 that reduces the contrast of an image of an object that is formed by light passing through the central region and the treatment portion compared to an image of an object that would be formed by light passing through only the central region 505. The peripheral zone 504 comprises a plurality of seed-shaped ballasts 509a, 509b, 509c, disposed on the anterior surface of the lens 501 and arranged at regular intervals around the circumference of the lens 501. These ballasts 509a, 509b, 509c are similar to the ballasts of the lenses shown in FIGS. 7, 8, 9A and 10A. The ballasts 509a, 509b, 509c, promote rotation of the lens 501, each having a thicker portion 510 and a thinner portion 512 and a smooth, curved upper surface that gives rise to a continually varying thickness, as shown in FIG. 11B. They are arranged around the circumference of the peripheral zone 504 to bias the lens 501 to rotate about the first optical axis in a clockwise direction, as indicated by the arrow 506. If a wearer of the lens 501 blinks, their eyelid will impart a force on the ballasts 509a, 509b, 509c, thereby causing the lens 501 to rotate.

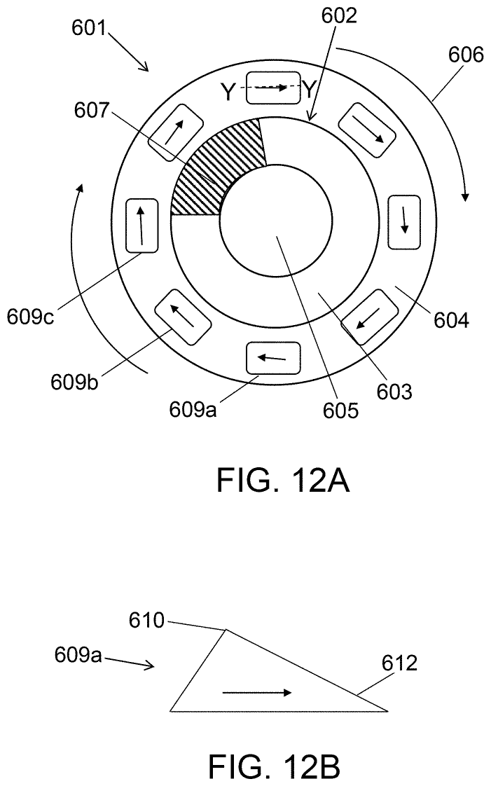

FIG. 12A shows a schematic top view of a lens 601 for use in the method of slowing progression of myopia (e.g., myopia control) according to an embodiment of the present disclosure. The optic zone 602 of the lens 601 is similar to the optic zone of the lens shown in FIG. 11A comprising a central region 605 surrounded by an annular region 603. The annular region 603 comprises a treatment portion 607 that reduces the contrast of an image of an object that is formed by light passing through the central region and the treatment portion compared to an image of an object that would be formed by light passing through only the central region 605. The peripheral zone 604 comprises a plurality of prism-shaped ballasts 609a, 609b, 609c, disposed on the anterior surface of the lens 601, and arranged at regular around the circumference of the lens 601. The ballasts 609a, 609b, 609c promote rotation of the lens 601 in the direction indicated by the arrow 606. Each prism-shaped ballast 609a, 609b, 609c, has a thick portion 610 and a thin portion 612 as shown in FIG. 12B, but in contrast to the seed-shaped ballasts 509a, 509b, 509c of FIGS. 11A and 11B the prisms 609a, 609b, 609c, which comprise flat, straight surfaces, which may aid controlled rotation of the lens 601.

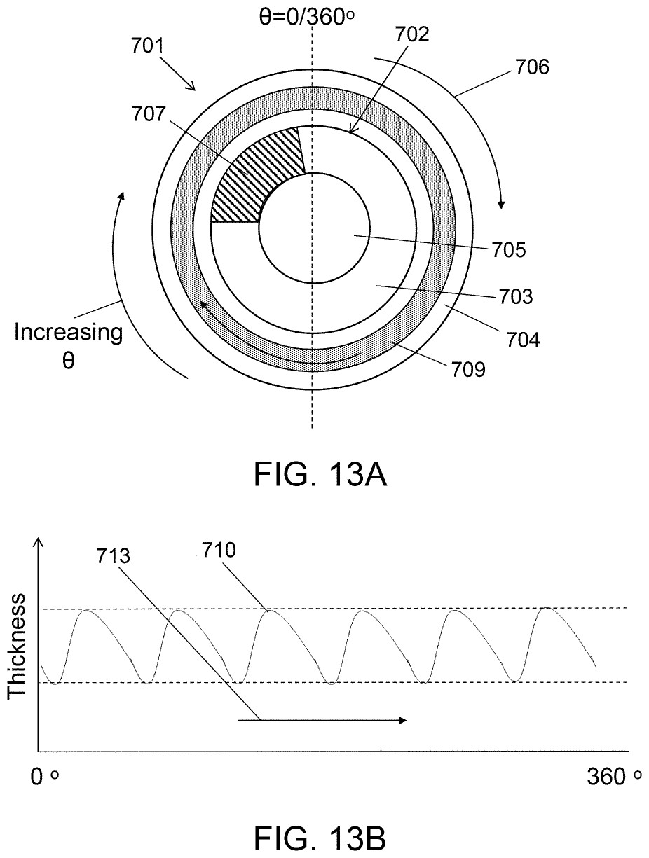

FIG. 13A shows a schematic top view of a lens 701 for use in the method of slowing progression of myopia (e.g., myopia control) according to an embodiment of the present disclosure. The optic zone 702 of the lens 701 is similar to the optic zone of the lenses shown in FIGS. 7,8 and 9A-12A, comprising a central region 705 surrounded by an annular region 703. The annular region 703 comprises a treatment portion 707 that reduces the contrast of an image of an object that is formed by light passing through the central region and the treatment portion 707 compared to an image of an object that would be formed by light passing through only the central region 705. The peripheral zone 704 comprises a continuous band 709 that has a periodically varying thickness profile. The periodically varying thickness profile comprises a plurality of peaks spaced around the circumference of the peripheral zone 704. Defining the position around the circumference of the lens by an angle θ, where theta varies between 0° and 360° (the continuous band 709 has a peak 710 in thickness every 60°, as shown in FIG. 13B). In order to promote rotation of the lens in the direction indicated by the arrow 706, each peak 710 has an asymmetric profile, which promotes rotation of the lens 701 in the direction indicated by arrow 713 in FIG. 13B.

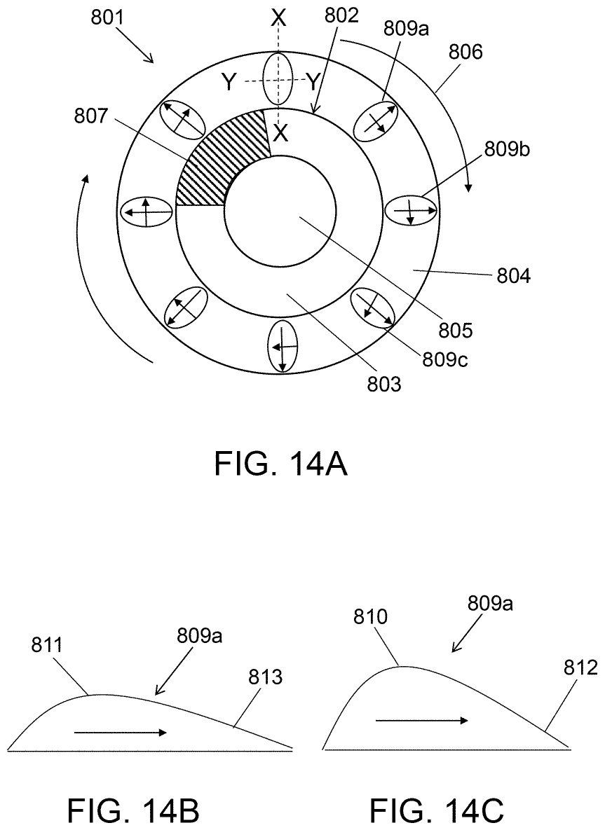

FIG. 14A shows a schematic top view of a lens 801 for use in the method of slowing progression of myopia (e.g., myopia control) according to an embodiment of the present disclosure. The optic zone 802 of the lens 801 is similar to the optic zone of the lenses shown in FIGS. 7, 8 and 9A-13A, comprising a central region 805 surrounded by an annular region 803. The annular region 803 comprises a treatment portion 807 that reduces the contrast of an image of an object that is formed by light passing through the central region and the treatment portion compared to an image of an object that would be formed by light passing through only the central region 805. The peripheral zone 804 comprises a plurality of ballasts 809a, 809b, 809c, disposed on the anterior surface of the lens 801 and arranged at regular intervals around the circumference of the lens 801. The ballasts 809a, 809b, 809c are elongated in a radial direction. Each ballast 809a, 809b, 809c has a continually varying thickness profile along the line Y-Y, as shown in FIG. 14C with a thicker portion 810 and a thinner portion 812, and the ballasts 809a, 809b, 809c are arranged around the circumference of the peripheral zone 804 to promote rotation of the lens 801 in the direction of the arrow 806. Additionally, each ballast 809a, 809b, 809c, has a varying thickness profile along the line X-X (as shown in FIG. 14B), having a thicker portion 811 towards the centre of the lens 801, and a thinner portion 813 towards the outer edge of the peripheral zone 804.

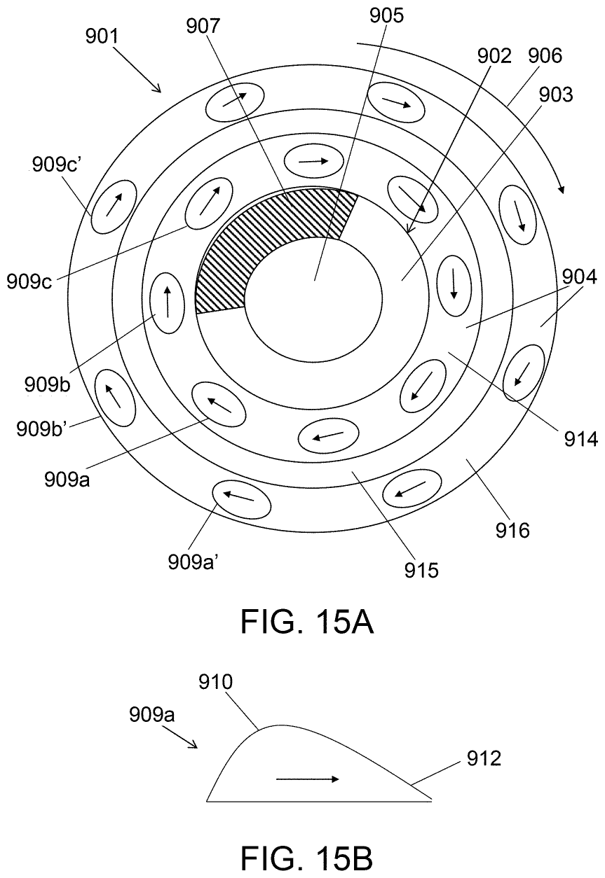

FIG. 15A shows a schematic top view of a lens 901 for use in the method of slowing progression of myopia (e.g., myopia control) according to an embodiment of the present disclosure. The optic zone 902 of the lens 901 is similar to the optic zone of the lenses shown in FIGS. 7, 8 and 9A-14A comprising a central region 905 surrounded by an annular region 903. The annular region 903 comprises a treatment portion 907 that reduces the contrast of an image of an object that is formed by light passing through the central region and the treatment portion compared to an image of an object that would be formed by light passing through only the central region 905. The peripheral zone 904 comprises two concentric regions 914, 916, each having a periodically varying thickness profile, separated by a region that has a constant thickness profile 915. Each concentric region 914, 916, comprises a plurality of seed-shaped ballasts 909a, 909b, 909c, 909a′, 909b′, 909c′ disposed on the anterior surface of the lens 901 and arranged at regular intervals around the circumference of the lens 901. These ballasts 909a, 909b, 909c, 909a′, 909b′, 909c′ promote rotation of the lens 901. The ballasts 909a, 909b, 909c, 909a′, 909b′, 909c′ each have a thicker portion 910 and a thinner portion 912 and a smooth, curved outer surface that gives rise to a continually varying thickness, as shown in FIG. 15B. For each of the concentric regions 914, 916, the ballasts 909a, 909b, 909c, 909a′, 909b′, 909c′ are arranged at regular intervals around the peripheral zone 904, but the ballasts 909a, 909b, 909c of the first region 914 are out of phase with the ballasts 909a′, 909b′, 909c′ of the second region 916. The ballasts 909a, 909b, 909c, 909a′, 909b′, 909c′ bias the lens 901 to rotate about the first optical axis in a clockwise direction, as indicated by the arrow 906. If a wearer of the lens 901 blinks, their eyelid will impart a force on the ballasts 909a, 909b, 909c, 909a′, 909b′, 909c′, thereby causing the lens 901 to rotate.

In other embodiments of the present disclosure, the ballasts disposed on concentric regions of the peripheral zone may be in phase for each of the concentric regions.

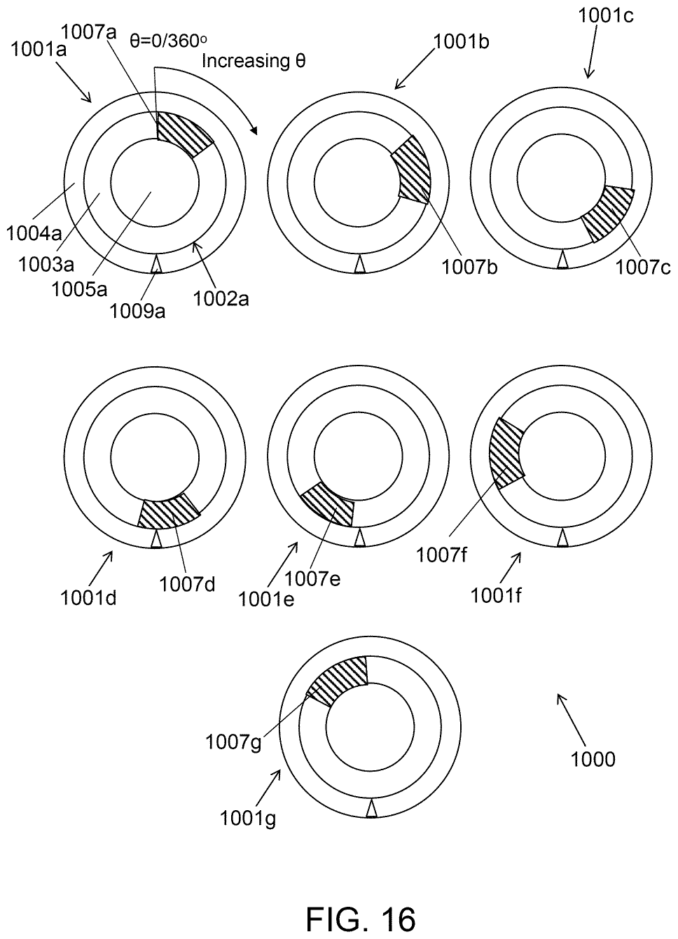

FIG. 16 shows a set of contact lenses 1000 for use in the method of slowing progression of myopia (e.g., myopia control) according to an embodiment of the present disclosure. The set comprises seven lenses 1001a-g. Each lens 1001a-g comprises an optic zone 1002a (shown in lens 1001a and would be the same in other lenses 1001b-g shown in FIG. 16), which approximately covers the pupil, and a peripheral zone 1004a (shown in lens 1001a and would be in same location in other lenses 1001b-g shown in FIG. 16) that sits over the iris. The peripheral zones 1004a provide mechanical functions, including increasing the size of the lenses 1001a-g thereby making the lenses 1001a-g easier to handle, and providing a shaped region that improves comfort for the lens wearer. The peripheral zones 1004a have a variation in thickness provided by ballasts 1009a (shown in lens 1001a and would be the same in other lenses 1001b-g shown in FIG. 16). For each lens 1001a-g in the set, the variation in thickness of the peripheral zone is the same. For each of the lenses 1001a-g in this set, the ballasts 1009a are positioned at the bottom of the lens (i.e., in the inferior half), along the diameter that separates the temporal and nasal halves of the lens 1001a-g. The ballasts 1009a control the rotation of the lenses 1001a-g, such that when the lenses 1001a-g are being worn, they remain in a stable position in spite of rotational forces from the wearer blinking. The optic zones 1002a, provide the optical functionality of the lenses 1001a-g. Each of the optic zones 1002a comprises an annular region 1003a and a central region 1005a (shown in lens 1001a and would be the same in other lenses 1001b-g shown in FIG. 16). Each annular region 1003a comprises a treatment portion 1007a-g that reduces the contrast of an image of an object that is formed by light passing through the central region 1005a and the treatment portion 1007a-g compared to an image of an object that would be formed by light passing through only the central region 1005a. Defining the position around the circumference of the lenses 1001a-g by an angle θ, where theta varies between 0° and 360°, the first lens 1001a has a treatment portion 1007a that spans approximately 40-90° around the annular region 1003a, and the second lens 1001b has a treatment portion 1007a that spans approximately 350-40°. Each lens 1001a-g in the set has a treatment portion 1007a-g that spans a different sector of the annular region 1003a relative to the ballast 1009a. If a wearer wears the lenses 1001a-g on successive days, the treatment portion 1007a-g will target different regions of the retina at different times.

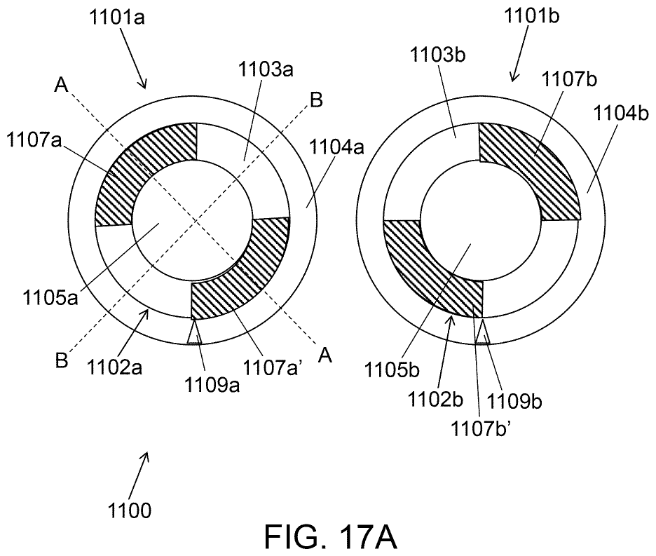

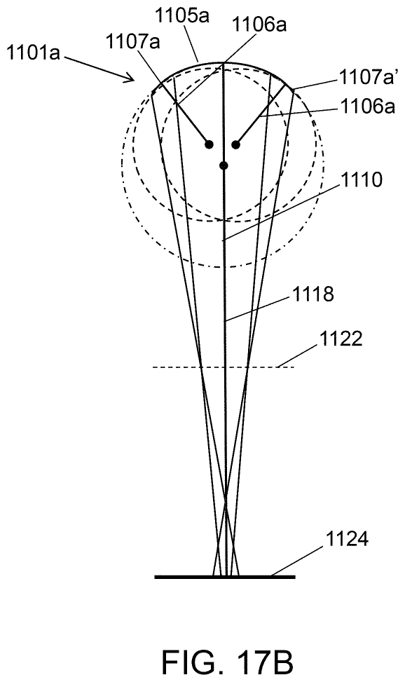

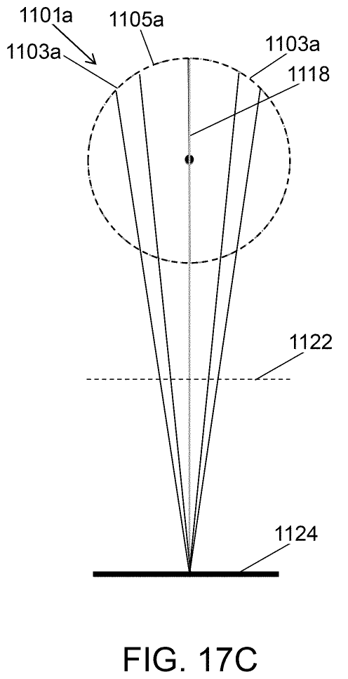

FIG. 17A shows a set of contact lenses 1100 for use in the method of slowing progression of myopia (e.g., myopia control) according to an embodiment of the present disclosure. The set comprises two lenses 1101a, 1101b. Each lens 1101a, 1101b comprises an optic zone 1102a, 1102b, which approximately covers the pupil, and a peripheral zone 1104a, 1104b that sits over the iris. The peripheral zones 1104a, 1104b provide mechanical functions, including increasing the size of the lenses 1101a, 1101b thereby making the lenses 1101a, 1101b easier to handle, and providing a shaped region that improves comfort for the lens wearer. The peripheral zones 1104a, 1104b have a variation in thickness provided by ballasts 1109a, 1109b. For each lens 1101a, 1101b in the set, the variation in thickness of the peripheral zone 1104a, 1104b is the same. For each of the lenses 1101a, 1101b in this set, the ballasts 1109a, 1109b are positioned at the bottom of the lens 1101a, 1101b (i.e. in the inferior half), along the diameter that separates the temporal and nasal halves of the lens 1101a, 1101b. The ballasts 1109a, 1109b control the rotation of the lenses 1101a, 1101b, such that when the lenses 1101a, 1101b are being worn, they remain in a stable position in spite of rotational forces from the wearer blinking. The optic zones 1102a, 1102b, provide the optical functionality of the lenses 1101a, 1101b. Each of the optic zones 1102a, 1102b comprises an annular region 1103a, 1103b and a central region 1105a, 1105b. Each annular region 1103a, 1103b comprises two treatment portions 1107a, 1107b, 1107a′, 1107b′ that reduces the contrast of an image of an object that is formed by light passing through the central region 1105a, 1105b and the treatment portion 1107a, 1107b, 1107a′, 1107b′ compared to an image of an object that would be formed by light passing through only the central region 1105a, 1105b. Defining the position around the circumference of the lenses 1101a, 1101b an angle θ, where theta varies between 0° and 360°, the first lens 1101a has a first treatment portion 1107a that spans the superior-temporal quadrant, or 270-360° around the annular region 1103a, and a second treatment portion 1107a′ that spans the inferior-nasal quadrant, or 90-180° around the annular region 1103a. The second lens 1101b has a first treatment portion 1107b that spans the superior-nasal quadrant, or 0-90° around the annular region 1103b and a second treatment portion 1107b′ that spans the inferior-temporal quadrant, or 180-270° around the annular region 1103b.

Each lens 1101a, 1101b in the set 1100 has 2 treatment portions 1107a, 1107b, 1107a′, 1107b′, and the treatment portion of each lens span different segments of the annular region 1103a, 1103b relative to the ballast 1109a, 1109b. If a wearer wears the lenses 1101a, 1101b on successive days, the treatment portion 1107a, 1107b, 1107a′, 1107b′ will target different regions of the retina at different times.

For the lenses 1101a, 1101b of FIG. 17A, each treatment portion 1107a, 1107b, 1107a′, 1107b′ has a curvature that provides an add power. For each lens, the central region 1105a, 1105b has a curvature providing a base power and centred on a centre of curvature that is on the first optical axis 1118. This is shown in FIG. 17B which is a schematic of a cross section through the first lens 1101a in the set taken along the line A-A.

Each treatment portion 1107a, 1107a′ has a curvature that provides an add power. The radius of curvature 1106a of the anterior surface of the treatment portion 1107a, 1107a′ (indicated by the dashed circles) is smaller than the radius of curvature 1110 of the anterior surface of the central region 1105a (indicated by the dot-dash circle). The treatment portion 1107a, 1107a′ therefore have a greater power than the base power of the central region 1105. Each of the treatment portions 1107a, 1107a′ has the same anterior curvature and the same power. As shown in FIG. 17B, the focal point of the treatment portions 1107a, 1107a′ lies on a proximal focal surface 1122, and the focal point for the central region 1105a lies on a distal focal surface 1124, which is further away from the posterior surface of the lens 1101a. The focal point 1122 of the treatment portion 1107a, 1107a′ and the focal point 1124 of the central region 1105a share a common optical axis 1118. For a point source at infinity, light rays focused by the central region 1105a form a focused image at the distal focal surface 1124. Light rays focused by the central region 1105a also produce an unfocused blur spot at the proximal focal surface 1122. Light rays focused by the treatment portions 1107a, 1107a′ form a focused image at the proximal focal surface 1122. Light rays focused by the treatment portions 1107a, 1107a′ diverge after the proximal focal surface 1122.

The add power treatment portions 1107a, 1107a′reduce the contrast of an image of an object that is formed by light passing through the central region and the treatment portion compared to an image of an object that would be formed by light passing through only the central region 1105a. In between the treatment portions 1107a, 1107a′ there are regions that do not significantly reduce the contrast of an image formed by light passing through the lens 1101a. For the lens 1101a of FIG. 17A, these regions have the base power, and as shown in FIG. 17C, which shows a cross section through the lens 1101a taken along the line B-B, light passing through these regions will be focused at the distal focal surface 1124.

The second lens 1101b in the set 1100 has treatment portions 1107b, 1107b′ spanning opposite quadrants. Therefore, if the wearer wears the two lenses 1101a, 1101b on successive days, on the first day, the treatment portions 1107a, 1107a′ of the first lens 1101a will target add power at a first two quadrants (in this case, the inferior-nasal and superior-temporal quadrants) and on the second day, the treatment portions 1107b, 1107b′ of the second lens 1101b will target add power at a second, different two quadrants (in this case, the inferior-temporal and superior-nasal quadrants).

In the embodiment shown in FIG. 17A, the 2 treatment portions of each lens have the same power. In other embodiments, the 2 treatment portions may have different powers.

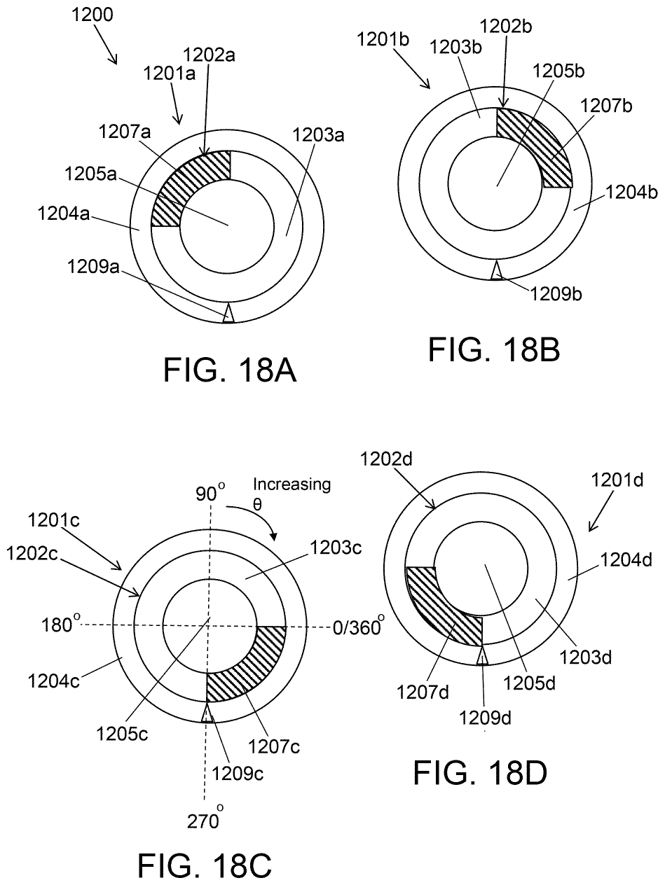

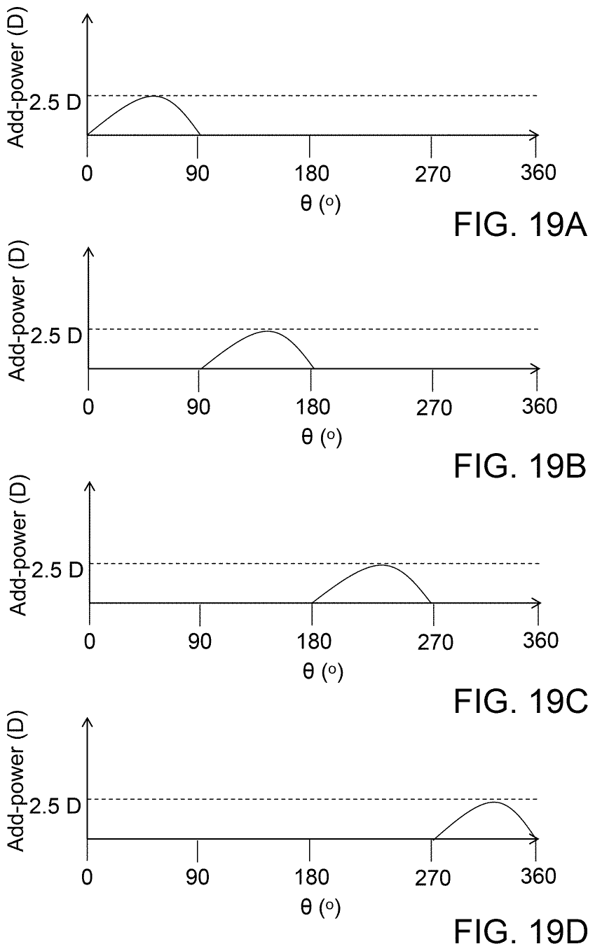

FIGS. 18A-D show a set of contact lenses 1200 for use in the method of slowing progression of myopia (e.g., myopia control) according to an embodiment of the present disclosure. The set 1200 comprises four lenses 1201a-d. Each lens 1201a-d comprises an optic zone 1202a-d, which approximately covers the pupil, and a peripheral zone 1204a-d that sits over the iris. The peripheral zones 1204a-d provide mechanical functions, including increasing the size of the lenses 1201a-d thereby making the lenses 1201a-d easier to handle, and providing a shaped region that improves comfort for the lens wearer. The peripheral zones 1204a-d have a variation in thickness provided by ballasts 1209a-d. For each lens 1201a-d in the set, the variation in thickness of the peripheral zone 1204a-d is the same. For each of the lenses 1201a-d in this set, the ballasts 1209a-d are positioned at the bottom of the lens 1201a-d (i.e. in the inferior half), along the diameter that separates the temporal and nasal halves of the lens 1201a-d. The ballasts 1209a-d control the rotation of the lenses 1201a-d such that when the lenses 1201a-d are being worn, they remain in a stable position in spite of rotational forces from the wearer blinking. The optic zones 1202a-d, provide the optical functionality of the lenses 1201a-d. Each of the optic zones 1202a-d comprises an annular region 1203a-d and a central region 1205a-d. Each annular region 1203a-d comprises a treatment portion 1207a-d that reduces the contrast of an image that is formed by light passing through the central region 1205a-d and the treatment portion 1207a-d compared to an image of an object that would be formed by light passing through only the central region 1205a-d. The contrast reduction varies with meridian around the annular region 1203a-d. This is shown by the graphs of FIG. 19A-D, which show the variation in add-power with meridian for the lenses of FIGS. 18A-D respectively Defining the position around the circumference of the lenses 1201a-d by an angle θ, where θ varies between 0° and 360°, the first lens 1201a has a first treatment portion 1207a that spans the superior-temporal quadrant, or 90-180° around the annular region 1203a, the second lens 1201b has a second treatment portion 1207b that spans the superior-nasal quadrant or 0/360-90° around the annular region 1203b, the third lens 1201c has a treatment portion 1207c that spans the inferior-nasal quadrant or 270-0/360° around the annular region 1203c, and the fourth lens 1201d has a treatment portion 1207d that spans the inferior-temporal quadrant or 180-270° around the annular region 1203d.

Each lens 1201a-d in the set therefore has treatment portion 1207a-d that spans a different segment of the annular region 1203a-d relative to the ballast 1209a-d. If a wearer wears the lenses 1201a-d on successive days, the treatment portion 1207a-d will target different regions of the retina.

For the lenses 1201a-d of FIGS. 18A-D, each treatment portion 1207a-d has a curvature that provides an add power. For each lens, the central region 1205 has a curvature providing a base power and centred on a centre of curvature that is on the first optical axis.

Each treatment portion 1207a-d has a curvature that provides an add power. The radius of curvature of the anterior surface of the treatment portions 1207a-d is smaller than the radius of curvature of the anterior surface of the central region 1205a-d. The treatment portions 1207a-d therefore have a greater power than the base power of the central region 1205a-d. Each of the treatment portions 1207a-d has the same anterior curvature and the same power, and each of the treatment portions has an asymmetric anterior surface curvature, which gives rise to an asymmetric power profile. Examples asymmetric power profiles are shown for each of the lenses in the set 1200 in FIGS. 18A-D. For each lens 1201a-d, the treatment portion 1207b-d is rotated by 90° around the annular region 1203(a)-(d) in a clockwise direction.

The embodiments shown in FIGS. 4-7 above show examples of different treatment portions for lenses that may be used in methods that fall within the scope of the present disclosure. Embodiments shown in FIGS. 7-15 show example peripheral zone thickness profile variations that promote rotation of lenses, thereby enabling rotation of a treatment portion. Such lenses may be used in methods according to embodiments of the present disclosure. FIGS. 16-18 show lenses that form part of lens sets that can be used to rotate a treatment portion. Such lenses may be used in methods according to embodiments of the present disclosure. It will be appreciated by those of ordinary skill in the art that features of these example embodiments may be combined in other embodiments that fall within the scope of the present disclosure.

Whilst in the foregoing description, integers or elements are mentioned which have known obvious or foreseeable equivalents, then such equivalents are herein incorporated as if individually set forth. Reference should be made to the claims for determining the true scope of the present disclosure, which should be construed as to encompass any such equivalents. It will also be appreciated by the reader that integers or features of the disclosure that are described as advantageous, convenient or the like are optional, and do not limit the scope of the independent claims. Moreover, it is to be understood that such optional integers or features, whilst of possible benefit in some embodiments of the disclosure, may not be desirable and may therefore be absent in other embodiments.

1. A method of reducing progression of myopia, comprising:
providing at least one contact lens having an optic zone and a peripheral zone surrounding the optic zone, the optic zone comprising a central region and an annular region that surrounds the central region, the annular region including a treatment portion that is not rotationally symmetric about an axis of the lens; and
rotating about the axis, over time, the treatment portion of the at least one contact lens on the eye, wherein the rotation reduces adaptation to a treatment stimulus by the person over time.

2. The method according to claim 1, wherein the treatment portion of each of the at least one lenses spans less than 50% of the annular region.

3. The method according to claim 1, wherein rotating the treatment portion over time comprises rotating the treatment portion in discrete rotation steps.

4. The method according to claim 3, wherein each rotation step is a rotation by 90° about the axis of the lens and relative to the lens wearer's retina.

5. The method according to claim 3 wherein each rotation step is a rotation by 10° about the axis of the lens and relative to the lens wearer's retina.

6. The method according to claim 1, wherein rotation of the treatment portion occurs on a timescale of seconds.

7. The method according to claim 1, wherein rotation of the treatment portion occurs on a timescale of days.

8. The method according to claim 1, wherein the treatment portion of each of the at least one lenses has a characteristic that reduces the contrast of an image that is formed by light passing through the central region and the treatment portion, compared to an image of an object that would be formed by light passing through only the central region.

9. The method according to claim 1, comprising providing a contact lens that that is configured to rotate in response to a force when worn by a wearer, and wherein the step of rotating comprises subjecting the lens to a force imparted by the lens wearer, wherein the force results in rotation of the treatment portion.

10. The method according to claim 9, wherein the step of rotating comprises a lens wearer blinking, thereby imparting a force on the lens.

11. The method according to claim 9, wherein the peripheral zone of each of the at least one lenses comprises a variation in thickness configured to promote rotation of the lens.

12. The method according to claim 9, wherein the thickness profile of each of the at least one lenses has no axis of mirror symmetry or is rotationally asymmetric.

13. The method according to claim 9, wherein the thickness of the peripheral zone varies periodically around the lens.

14. The method according to claim 13, wherein the periodic variation is a sinusoid, triangular or sawtooth waveform.

15. The method according to claim 1, comprising providing at least two lenses, wherein a first lens provides a treatment portion that is configured to span a first region of the lens wearer's eye, and wherein at least one additional lens provides a treatment portion that is configured to span a different region of the lens wearer's eye, and wherein the step of rotating comprises a wearer wearing the first lens and then each of the at least one additional lenses in succession.

16. The method according to claim 15, wherein the peripheral zone of each lens has a varying thickness profile that is configured to control rotation of the lens, and wherein the first lens has a treatment portion rotationally positioned relative to the peripheral zone thickness profile, at a first angle, and the each of the at least one additional lenses has a treatment portion that is rotationally positioned, relative to the peripheral zone thickness profile at a different angle.

17. The method according to claim 15, wherein rotating the treatment portion comprises a lens wearer removing and replacing the first lens with one of the additional lenses after a day.

18. The method according to claim 15, wherein rotating the treatment portion comprises a lens wearer alternating between wearing a first lens and each one of the additional lenses.

19. The method according to claim 15, comprising providing a lens wearer with a prescription schedule indicating the order in which the first lens and each of the at least one additional lenses should be worn and/or how long each lens should be worn for.

20. The method according to claim 15, comprising providing a lens wearer with a set of 7 lenses for wearing on each day of the week, wherein the step of rotating the treatment zone comprises wearing each of the lenses on successive days.
